(19) United States
(12) Patent Application Publication
(10) Pub. No.: US 2016/0346997 A1
(43) Pub. Date: Dec. 1, 2016

(54) THREE-DIMENSIONAL (3D) PRINTED COMPOSITE STRUCTURE AND 3D PRINTABLE COMPOSITE INK FORMULATION

(71) Applicant: PRESIDENT AND FELLOWS OF HARVARD COLLEGE, Cambridge, MA (US)

(72) Inventors: Jennifer A. Lewis, Cambridge, MA (US); Brett G. Compton, Knoxville, TN (US); Jordan R. Raney, Watertown, MA (US); Thomas J. Ober, Cambridge, MA (US)

(73) Assignee: President and Fellows of Harvard College, Cambridge, MA (US)

(21) Appl. No.: 15/117,623

(22) PCT Filed: Feb. 10, 2015
(86) PCT No.: PCT/US15/15148

§ 371 Date: Aug. 9, 2016

Related U.S. Application Data
(60) Provisional application No. 61/937,818, filed on Feb. 10, 2014.
(60) Provisional application No. 62/080,576, filed on Nov. 17, 2014.

(51) Int. Cl. B29C 67/00; B33Y 70/00; B33Y 80/00; B33Y 10/00

(52) U.S. Cl. CPC B29C 67/0055; B33Y 10/00; B33Y 70/00; B33Y 80/00; B29K 2105/124

(57) ABSTRACT

A filamentary structure extruded from a nozzle during 3D printing comprises a continuous filament including filler particles dispersed therein. At least some fraction of the filler particles in the continuous filament comprise high aspect ratio particles having a predetermined orientation with respect to a longitudinal axis of the continuous filament. The high aspect ratio particles may be at least partially aligned along the longitudinal axis of the continuous filament. In some embodiments, the high aspect ratio particles may be highly aligned along the longitudinal axis. Also or alternatively, at least some fraction of the high aspect ratio particles may have a helical orientation comprising a circumferential component and a longitudinal component, where the circumferential component is imparted by rotation of a deposition nozzle and the longitudinal component is imparted by translation of the deposition nozzle.

### RELATED APPLICATIONS

The present patent document claims the benefit of priority under 35 U.S.C. 119(e) to U.S. Provisional Patent Application Ser. No. 61/937,818, filed Feb. 10, 2014, and to U.S. Provisional Patent Application Ser. No. 62/080,576, filed Nov. 17, 2014, both of which are hereby incorporated by reference in their entirety.

### TECHNICAL FIELD

The present disclosure is related generally to three-dimensional printing (3D printing) and more particularly to 3D printed composite structures.

### BACKGROUND

With the growing need for lightweight, high-performance structural materials, cellular materials have become increasingly more relevant over the past several decades because of their low density, high specific properties, and potential for multifunctionality (e.g., structural, transport, electrical and magnetic applications). Such materials are utilized in high stiffness sandwich panels, energy absorbers, catalytic materials, vibration damping, insulation, and other products. In this class of materials, the properties of the bulk may depend on i.) the base material from which the cellular structure is made, ii.) the topology and shape of the cells (i.e., the architecture), and iii.) the relative density of the material, that is, the density of the cellular structure relative to the density of the base material. Therefore, the development of high performance base materials amenable to fabrication into cellular structures with controlled architecture is of paramount importance. When the architecture can be controlled, properties can be optimized to the desired application. Materials which exhibit ordered architecture and hierarchy may achieve properties far superior to equivalent composites with random architecture (La, random composites or foams containing the same constituents at the same volume fractions). For example, nacre has a work of fracture value ˜150 times higher than the simple average of the individual constituents, and wood still rivals the best engineering materials in terms of specific bending stiffness (E^{1/2}/ρ) and specific bending strength (σ^{2/3}/ρ). Advances in the fabrication of synthetic cellular materials, which enable finer control over architecture at multiple length scales, could lead to drastic increases in material properties, wider commercial use and substantial improvements in mass efficiency over existing engineering materials and systems.

As a prime example of a natural material with complex architecture, wood utilizes microscopic bundles of highly oriented cellulose nano-fibrils in a multi-orientation layup within the walls of its cellular structure to achieve extremely high specific stiffness and strength. To demonstrate the importance of controlling fiber orientation in a similar engineering system, a series of finite element analyses were conducted using Abaqus software (Dassault Systèmes, France) on a fiber composite in a triangular honeycomb geometry. Referring to FIG. 1A, the walls of the cellular structure include symmetric, two-ply layups of unidirectional laminae with specified orientation of ±θ and elastic properties representative of 30 vol. % carbon fiber in an epoxy matrix. Various load cases were applied to the structure (see FIGS. 1B and 1C) to determine the elastic properties of the complete structure as a function of fiber orientation within the cell walls. The results are shown in FIG. 1D and clearly indicate the importance of controlling fiber orientation to optimize properties for a given load case: at ±0° orientation, the in-plane stiffness is significantly higher than the through-thickness or shear stiffness, while at ±90° the in-plane stiffness is reduced to less than that of the matrix alone, and the through-thickness stiffness is at a maximum. When the orientation is ±45°, the through-thickness shear stiffness is at a maximum and is actually higher than either the in-plane or through-thickness compressive stiffness values. Control over fiber orientation may be critical for the design of optimized, multifunctional sandwich panels and cellular structures.

### BRIEF SUMMARY

A 3D printable composite ink formulation comprises an uncured polymer resin, filler particles, and a latent curing agent, where the composite ink formulation comprises a strain-rate dependent viscosity and a plateau value of elastic storage modulus G′ of at least about 10³ Pa.

A filamentary structure extruded from a nozzle during 3D printing comprises a continuous filament including filler particles dispersed therein. At least some fraction of the filler particles in the continuous filament comprise high aspect ratio particles having a predetermined orientation with respect to a longitudinal axis of the continuous filament.

A filamentary structure extruded from a nozzle during 3D printing comprises a continuous filament including high aspect ratio particles dispersed therein. At least some fraction of the high aspect ratio particles in the continuous filament have a helical orientation comprising a circumferential component and a longitudinal component, where the circumferential component is imparted by rotation of a deposition nozzle and the longitudinal component is imparted by translation of the deposition nozzle.

A 3D printed composite structure comprises a polymer composite including a thermoset polymer matrix and filler particles dispersed therein, where the polymer composite is made by the following process: a continuous filament is deposited on a substrate in a predetermined pattern layer by layer. The continuous filament comprises a composite ink formulation including an uncured polymer resin, filler particles, and a latent curing agent. The filler particles include high aspect ratio particles that are at least partially aligned along a longitudinal axis of the continuous filament when deposited. The composite ink formulation is cured, preferably after deposition, to form the polymer composite, and the high aspect ratio particles have a predetermined orientation in the thermoset polymer matrix.

A 3D printed composite structure comprises a polymer composite including a polymer matrix and oriented high aspect ratio particles dispersed therein, wherein the polymer composite is made by: extruding a continuous filament from a nozzle while the nozzle rotates about a longitudinal axis thereof and translates with respect to a substrate, the continuous filament comprising a composite ink formulation including high aspect ratio particles in a flowable matrix material; depositing the continuous filament in a predetermined pattern on the substrate, where at least some fraction of the high aspect ratio particles in the continuous filament have an orientation comprising a circumferential component due to rotation of the nozzle and a longitudinal component due to translation of the nozzle; and processing the continuous filament to form the polymer matrix with oriented high aspect ratio particles dispersed therein.

A 3D printed lattice structure comprises a microlattice comprising a plurality of layers of extruded filaments arranged in a crisscross pattern. The extruded filaments comprise a polymer composite including a polymer matrix and high aspect ratio particles dispersed therein. The high aspect ratio particles are at least partially aligned with a longitudinal axis of the respective extruded filament along a length thereof.

A 3D printed cellular structure comprises a cellular network comprising cell walls separating empty cells, where the cell walls comprise a polymer composite comprising filler particles dispersed in a polymer matrix. The filler particles comprise high aspect ratio particles having a predetermined orientation within the cell walls.

A 3D printed cellular structure comprises a cellular network of cell walls separating empty cells, where the cell walls comprise a polymer composite including filler particles dispersed in a polymer matrix. The filler particles may comprise high aspect ratio particles that are at least partially aligned with the cell walls along a length thereof.

A 3D printed cellular structure comprises a network of cell walls separating empty cells, where the cell walls comprise a polymer composite including high aspect ratio particles dispersed in a polymer matrix. At least about 20% of the high aspect ratio particles have a long axis oriented within about 80 degrees of a height direction of the cell walls.

A method of making a 3D printed composite structure may comprise depositing a continuous filament, which comprises a composite ink formulation including an uncured polymer resin, filler particles, and a latent curing agent, on a substrate in a predetermined pattern layer by layer. The filler particles include high aspect ratio particles at least partially aligned along a longitudinal axis of the continuous filament when deposited. The composite ink formulation is cured to form a polymer composite comprising a thermoset polymer matrix and the filler particles dispersed therein, where the high aspect ratio particles have a predetermined orientation in the thermoset polymer matrix.

A method of making a 3D printed cellular structure may comprise depositing a continuous filament, which comprises a composite ink formulation including an uncured polymer resin, filler particles, and a latent curing agent, on a substrate in a predetermined pattern layer by layer to form stacks of the continuous filament. The filler particles include high aspect ratio particles at least partially aligned along a longitudinal axis of the continuous filament when deposited. The composite ink formulation is cured to form a polymer composite comprising a thermoset polymer matrix and the filler particles dispersed therein. Upon curing, the stacks of the continuous filament form cell walls of a cellular structure comprising the polymer composite, and the high aspect ratio particles are at least partially aligned with the cell walls along a length thereof.

A method of making a 3D printed composite structure comprises extruding a continuous filament from a nozzle while the nozzle rotates about a longitudinal axis thereof and translates with respect to a substrate. The continuous filament comprises a composite ink formulation including high aspect ratio particles in a flowable matrix material. The continuous filament is deposited in a predetermined pattern on the substrate, where at least some fraction of the high aspect ratio particles in the continuous filament have a helical orientation comprising circumferential and longitudinal components due to rotational and translational motion of the nozzle.

An apparatus for 3D printing comprises: a 3D positioning stage for implementing translational motion; a nozzle assembly mounted on the 3D positioning stage, the nozzle assembly comprising a hollow stationary portion connected to a hollow rotatable portion; a motor mounted on the 3D positioning stage, the motor being operatively connected to the hollow rotatable portion to implement rotational motion thereof; and a controller electrically connected to the 3D positioning stage and to the motor for independently controlling the translational motion and the rotational motion of the nozzle assembly.

The terms “comprising,” “including,” and “having” are used interchangeably throughout this disclosure as open-ended terms to refer to the recited elements (or steps) without excluding unrecited elements (or steps).

### BRIEF DESCRIPTION OF THE DRAWINGS

FIG. 1A shows a perspective view of a composite triangular honeycomb structure analyzed using finite element analyses; the inset shows the symmetric orientation angle, θ, of the fiber reinforcement.

FIG. 1B shows in-plane loading cases for compression and shear.

FIG. 1C shows through-thickness loading cases for compression and shear.

FIG. 1D shows the result of finite element analyses of the honeycomb structures and loading cases shown in FIGS. 1A-1C, where the variation in normalized elastic stiffness with fiber orientation angle is plotted. The values are normalized by the relative density, ρ̅, and the Young's modulus of a single unidirectional composite ply along the direction of the fibers, E₁₁.

FIG. 2A shows an exemplary 3D printing process where a composite ink formulation is extruded through a nozzle to form a filament that is deposited on a substrate in a predetermined honeycomb pattern.

FIG. 2B is a schematic of an exemplary deposition process depicting the progressive alignment of high aspect ratio fillers within a deposition nozzle, resulting in printed filaments with highly aligned fillers.

FIGS. 2C-2E show images of square, hexagonal, and triangular 3D printed honeycomb structures, respectively; scale bars for the images are 2 mm.

FIGS. 2F-2H show a triangular honeycomb structure printed with an epoxy ink formulation containing carbon fibers. Optical micrographs of polished sections reveal highly aligned carbon fibers, with the orientation of the fibers following the print path of the nozzle (see, for example, the fiber “rounding the bend” on the left side of the node in FIG. 2H). The scale bar is 500 μm.

FIG. 3A shows viscosity versus shear rate behavior for an epoxy resin and several epoxy resin-based composite ink formulations.

FIG. 3B shows oscillatory shear stress—complex modulus data for an epoxy resin and several epoxy-resin based composite ink formulations.

FIG. 4 shows 3D printed composite structures comprising triangular honeycomb structures of different relative densities.

FIGS. 5A-5B show exemplary print paths and printed specimens for longitudinal tensile tests; the scale bar is 10 mm.

FIGS. 5C-5D show exemplary print paths and printed specimens for transverse tensile tests; the scale bar is 10 mm.

FIG. 6A shows representative tensile stress-strain curves for several composite ink formulations and a baseline cast epoxy.

FIGS. 6B and 6C show tensile fracture surfaces of longitudinally-printed and transversely-printed epoxy composite specimens, respectively, which show full coalescence of individual printed filaments and minimal large defects.

FIG. 6D shows an SEM micrograph that reveals extensive pullout of both the small SiC whiskers (nearly white in the micrograph) and the larger carbon fibers in the longitudinally-printed epoxy composite specimens.

FIG. 6E shows an SEM micrograph that reveals minimal pullout is observed in the transversely-printed epoxy composite specimens.

FIG. 6F shows representative compressive stress—strain curves for printed triangular honeycomb structures for a range of relative densities.

FIGS. 6G and 6H show still images from video of a mechanical test showing an initial failure event of node rotation (G), followed damage propagation from that site in the form of elastic wall buckling and tensile fracture (H); the scale bar is 10 mm.

FIGS. 6I and 6J show SEM images of a failure site in a printed honeycomb structure, where an imperfection in the cell wall may have caused the initial node rotation.

FIGS. 7A and 7B show property space maps of Young's modulus versus density, and strength versus density, respectively, comparing the 3D printed composite structures of this disclosure with commercial 3D printed polymers and polymer composites, as well as data for balsa wood.

FIG. 8 shows a 3D printed lattice structure.

FIGS. 9A-9B show side view and top view schematics, respectively, of a deposition nozzle having rotational and translational capabilities.

FIG. 10A shows an idealized fiber orientation schematic for a nozzle undergoing only translational motion with respect to a substrate.

FIG. 10B shows visualizations of idealized high aspect ratio particles (no matrix shown) at r=rₘₐₓ showing the evolution of particle orientation with increasing nozzle rotation rate. The side view demonstrates how a helical orientation about the filament axis leads to high aspect ratio particles with both +φ and −φ orientation in any plane containing the longitudinal axis of the filament.

FIGS. 11A-11C show top view images of exemplary continuous filaments comprising an epoxy matrix and carbon fibers dispersed therein printed at various ω/ν values.

FIG. 12A shows a hexagonal cellular (honeycomb) structure printed using a 0.610 mm diameter nozzle with a translation speed of 5 mm/s and a rotation rate of 86 rpm (9 rad/s).

FIG. 12B shows a top view of one of the cell walls of the cellular structure shown in FIG. 12A, where the high aspect ratio particles are predominantly oriented at an angle to the plane of the cell wall and filament axis.

FIG. 12C shows a side detail view of one of the cell walls of the cellular structure of FIG. 12A showing fibers strongly oriented at an angle to the plane of the layer. The orientation angle predicted from Equation (3) is indicated by the white dashed lines.

FIG. 12D shows, for comparison, a detail view of the cell wall of a cellular structure built without nozzle rotation where there is no preferential out-of-plane (or height direction) orientation.

FIG. 13A shows an exemplary 3D printing apparatus including a rotating nozzle assembly.

FIGS. 13B-13C show another exemplary 3D printing apparatus including a rotating nozzle assembly having an alternative design.

FIGS. 14A-14C show top view images of exemplary continuous filaments comprising an epoxy matrix and carbon fibers dispersed therein; the filaments are printed at the same translation speed but different rotation speeds 0, 65 rpm and 260 rpm, respectively.

FIG. 15A shows top views of continuous fibers produced by varying the rotation speed during deposition; the image shows how fiber alignment can be controlled during deposition to produce a filament comprising different fiber orientations along the length thereof. Bracketed regions of the continuous filaments show fibers oriented nearly perpendicular to the longitudinal axis of the filament, while the unbracketed regions contain fibers oriented substantially parallel to the filament axis.

FIG. 15B shows a top view of a node of a cellular structure and provides another example of spatial control of fiber alignment; fibers in the node region have off-axis alignment due to nozzle rotation during deposition, while fibers elsewhere in the continuous filament are aligned substantially along the longitudinal axis thereof.

FIGS. 16A and 16B provide a top view of a continuous filament produced by varying the rotation speed during deposition; the image shows how changes in fiber alignment can be achieved rapidly, and thus over short distances, during filament deposition.

FIG. 17 shows a top view of a continuous filament that includes protruding fibers.

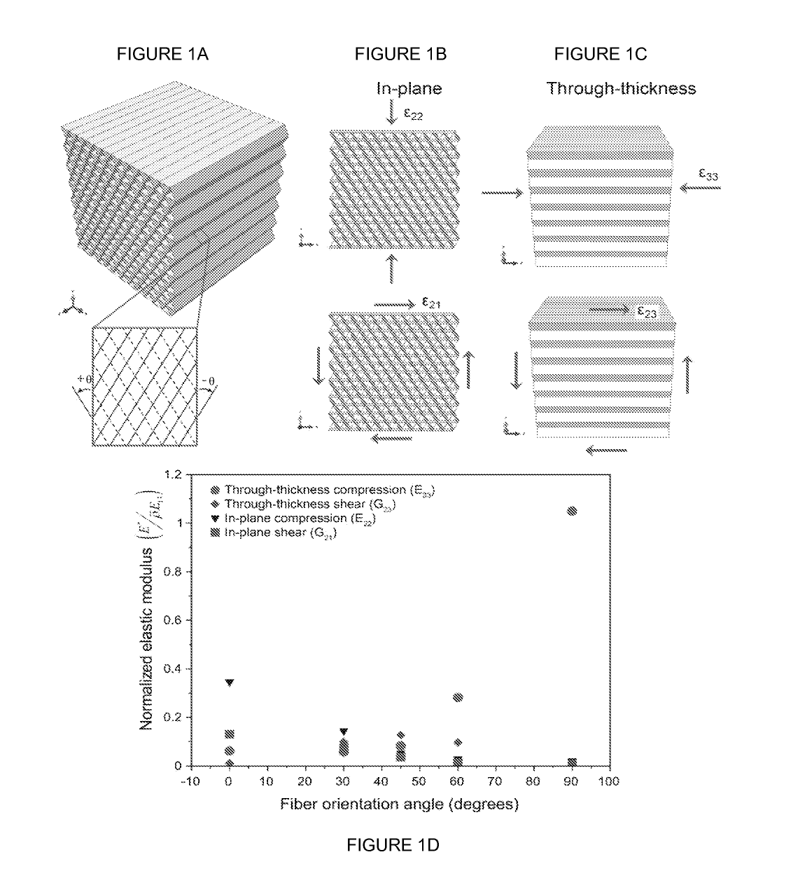

### DETAILED DESCRIPTION

3D printing techniques offer unparalleled flexibility in achievable geometric shape and complexity over existing manufacturing techniques. These methods, also called additive manufacturing, build components incrementally by adding material through a deposition process. A new 3D printable composite ink formulation has been developed that can be used to fabricate strong and lightweight composite structures, such as open or closed cellular structures inspired by wood and other natural materials. The composite ink formulation can maintain a filamentary shape and span large gaps without sag after being extruded through a nozzle. A new method of 3D printing that allows control over the orientation of high aspect ratio particles in the deposited filament and in the printed composite structure has also been developed. Printed and cured polymer composites prepared from the new ink formulation using the methods described herein have been shown to exhibit an order of magnitude higher Young's modulus than competing materials while retaining equivalent (or higher) strength.

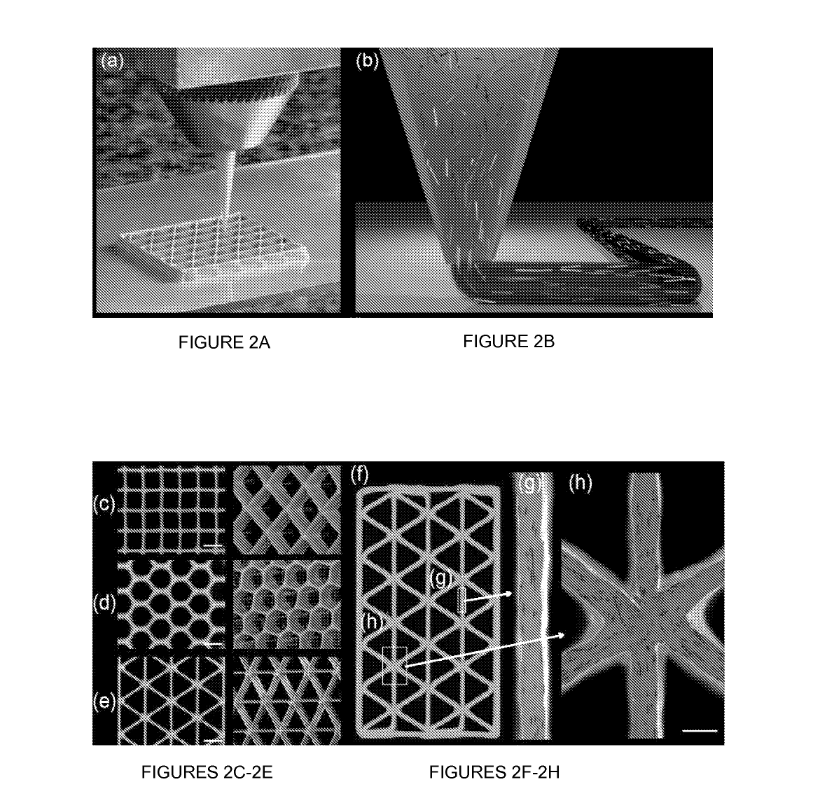

FIGS. 2A and 2B show schematics of the 3D printing process, which may also be referred to as 3D deposition, direct-write fabrication or direct-write robocasting. 3D printing entails flowing a rheologically-tailored ink composition through a deposition nozzle integrated with a moveable micropositioner having x-, y-, and z-direction capability. In the present method, the ink composition may include high aspect ratio particles that have a significant length-to-width aspect ratio, as shown schematically in FIG. 2B. As the nozzle is moved, a filament comprising the ink composition may be extruded through the nozzle and continuously deposited on a substrate in a configuration or pattern that depends on the motion of the micropositioner. In this way, 3D printing may be employed to build up 3D structures layer by layer, such as the exemplary cellular structures shown in FIGS. 2C-2F. The high aspect ratio particles may have a predetermined orientation in the deposited filament and in the printed composite structure.

The new method to control the orientation of high aspect ratio particles or fibers during 3D printing may involve introducing a rotational shear component to a composite ink formulation as it is being extruded through the deposition nozzle. This approach is enabled by the development of a 3D printing apparatus comprising a rotatable deposition nozzle that can be rotated at a specified rate about its axis, as set forth in greater detail below. The rotational motion may be controlled independently of the translational motion used to advance the deposition nozzle over a substrate to print a continuous filament, as shown schematically in FIGS. 2A and 2B.

High aspect ratio (or anisotropic) particles preferentially align along the direction of extension and shear in extensional and shear flows, respectively. In an extrusion process, this promotes particle alignment along the axis of extrusion; in an extrusion-based 3D printing process (e.g. direct-write printing or fused deposition modeling), the shear field between a translating nozzle and a stationary substrate may facilitate particle alignment along the print direction and within the plane of the printed layer. By introducing rotation to the nozzle during deposition, an additional shear field may be generated between the nozzle and the stationary substrate.

### Composite Ink Formulation

The new 3D printable composite ink formulation includes a flowable matrix material and filler particles dispersed therein. The 3D printable ink formulation may comprise a mixture of an uncured polymer resin, filler particles and a latent curing agent. The composite ink formulation may have a strain-rate dependent viscosity (and thus can be said to be shear-thinning or viscoelastic) and may exhibit a plateau value of shear storage elastic modulus G′ of at least about 10³ Pa. As is discussed in further detail below, the filler particles may include isotropic and/or anisotropic particles.

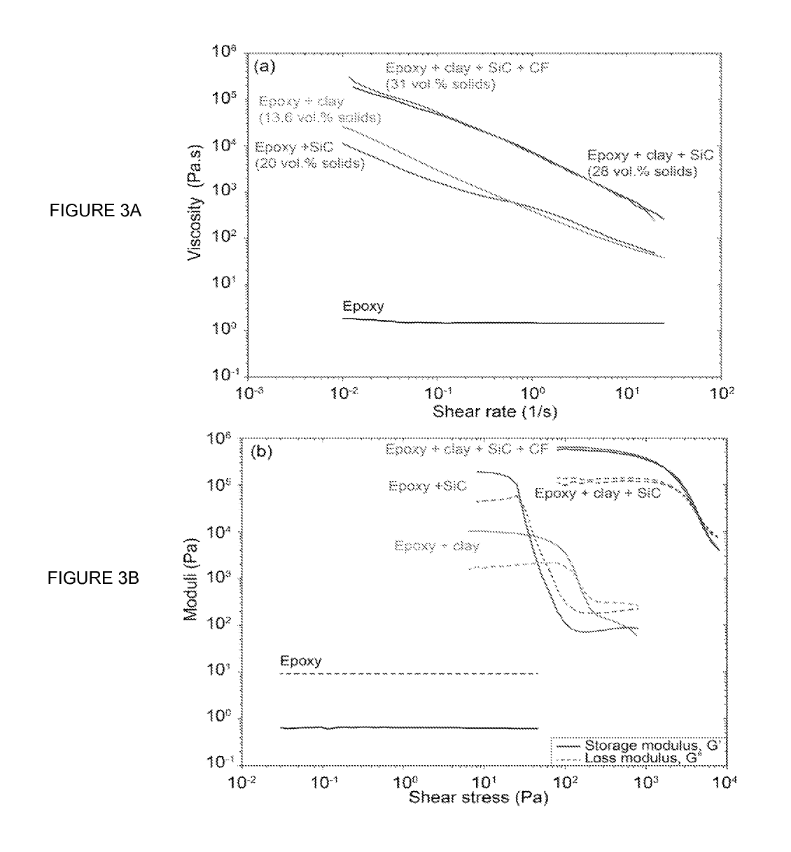

FIG. 3A shows viscosity as a function of shear rate and FIG. 3B shows moduli data (storage modulus G′ and loss modulus G″) for several exemplary composite ink formulations in comparison with an (unfilled) epoxy resin. The composition of each composite ink formulation is set forth in Table 1. Referring to FIG. 3A, the epoxy resin (without reinforcement or filler particles) exhibits rate-independent Newtonian flow behavior, while all of the composite ink formulations show a clear dependence of viscosity on shear rate. FIG. 3B reveals that the composite ink formulations exhibit significant shear thinning and yield stress behavior, again in contrast to the unreinforced epoxy resin. As can be seen, the plateau value of the storage elastic modulus G′ may in some cases be at least about 10⁴, Pa or at least about 10⁵ Pa, and may approach 10⁶ Pa. The composite ink formulation may also exhibit a shear yield stress of at least about 100 Pa.

TABLE 1
Exemplary Ink Formulations

| | | | | | Epoxy + clay + | Epoxy + clay + |
|---|---|---|---|---|---|---|
| | Epoxy + | Epoxy + clay + | Epoxy + clay + | Epoxy + clay | SiC ink | SiC + CF |
| Ink | clay ink | SiC ink | SiC + CF | ink (weight | (weight | ink (weight |
| constituents | (g) | (g) | ink (g) | fraction) | fraction) | fraction) |
| Epoxy resin | 30 | 30 | 30 | 0.632 | 0.48 | 0.455 |
| Acetone | 0 | 0 | 0.5 | 0 | 0 | 0.008 |
| DMMP | 3 | 3 | 3 | 0.063 | 0.048 | 0.045 |
| VS03 curing | 1.5 | 1.5 | 1.5 | 0.032 | 0.024 | 0.023 |
| agent | | | | | | |
| Nano-clay | 13 | 8 | 8 | 0.274 | 0.128 | 0.121 |
| SiC | 0 | 20 | 20 | 0 | 0.32 | 0.303 |
| whiskers | | | | | | |
| Carbon | 0 | 0 | 3 | 0 | 0 | 0.045 |
| fibers | | | | | | |

During printing, the rheology of the composite ink formulation influences the printability, height, and morphology of structures that can be fabricated. At rest, the ink formulation ideally has a sufficiently high elastic storage modulus, G′, and shear yield strength (as indicated by the shear stress value at which the storage and viscous moduli cross for a given composition as shown for example in FIG. 3B) to maintain the printed shape. Under a shear stress, the ink formulation ideally exhibits significant shear thinning to allow flow through small diameter nozzles without requiring prohibitively high driving pressures. When an ink formulation is properly designed, self-supporting structures can be made with filaments that span many times their diameter in free space.

An estimate of the storage modulus, G′, required for a filament to span a given distance with less than 5% sag is given by the following equation:

$${G}^{′} > \frac{1.4 ρ g {L}^{4}}{{D}^{3}} ,$$

where ρ is the mass density, g is the gravitational constant, L is the span length, and D is the filament diameter. The shear yield stress, T_{Y}, required to achieve a self-supporting structure with a given build height can be calculated as follows:

$${τ}_{Y} = \frac{ρ g h}{\sqrt{3}} ,$$

where h is the structure height. Time-dependent behavior, such as viscoelastic creep or solvent evaporation, are not considered by these equations.

As shown by the data of FIGS. 3A and 3B, filler particles may be incorporated into the ink formulation to alter the rheological properties of the uncured polymer resin. They may also be used to influence the mechanical properties of the printed composite structure, as discussed further below. The uncured polymer resin selected for the ink formulation may be a thermosetting polymer resin, such as an epoxy resin, a polyurethane resin, a polyester resin, a polyimide resin, or a polydimethylsiloxane (PDMS) resin that undergoes a cross-linking process when cured.

The latent curing agent used in the ink formulation prevents premature curing of the polymer resin; typically, curing is activated by heat exposure after the composite structure has been printed. In conventional 3D printing methods, drying, solidification and/or curing may occur during the printing process such that a deposited layer is partially or fully solidified before the next layer of ink is deposited. Such “on the fly” curing approaches may be required when the printing inks are not engineered with the rheological properties to withstand the layer-by-layer construction of large components. However, premature curing of the ink may lead unsatisfactory bonding between adjacent layers, thereby diminishing the mechanical integrity of the 3D printed structure and/or leading to component warpage due to differential shrinkage. The latent curing agent incorporated in the composite ink formulation may be activated by elevated temperatures in the range of 100° C. to about 300° C. and may have a long pot life, allowing a prepared ink formulation to print consistently over a long time period (e.g., up to about 30 days). Some latent curing agents that may be suitable for the composite ink formulation may be activated by UV light instead of heat. One example of a suitable latent curing agent for epoxy resin is an imidazole-based ionic liquid, such as VSO3 from BASF Group's Intermediates Division. Other commercially available latent curing agents may also be used.

The composite ink formulation may include the uncured polymer resin at a concentration of from about 30 wt. % to about 95 wt. % and the filler particles at a concentration of from about 5 wt. % to about 70 wt. %. The latent curing agent may be present in the ink formulation at a concentration of from greater than 0 wt. % to about 5 wt. %.

The concentration of the latent curing agent is more typically specified in terms of weight relative to the weight of the uncured polymer resin. Thus, the latent curing agent may be present at a weight concentration of from greater than 0 to about 15 parts per hundred parts of the uncured polymer resin.

The volume fraction of filler particles may be a stronger predictor of the rheology of the composite ink formulation than the weight fraction of particles. In other words, the rheology of a composite ink formulation including a high weight fraction of a very dense reinforcement may be similar or identical to that of a composite ink formulation containing a low weight fraction of a low density reinforcement—if the volume fraction of the filler particles is about the same for the two formulations. It is useful for this reason to specify a suitable volume fraction of filler particles for the composite ink formulation. Typically, a suitable range of solids loading (particle loading) is from about 5 vol. % to about 60 vol. %, independent of the weight fraction of the particles.

The composite ink formulation may further comprise an antiplasticizer such as, for example, dimethyl methyl phosphonate (DMMP). By including the antiplasticizer, the initial viscosity of the epoxy resin may be reduced to allow a higher concentration of filler particles. The antiplasticizer may also contribute to an increased stiffness and strength in the cured composite structure. The antiplasticizer may be present in the ink composition at a concentration of from about 0 wt. % to about 15 wt. %. As with the latent curing agent, the concentration of the antiplasticizer is more typically specified in terms of weight relative to the weight of the uncured polymer resin. Thus, the antiplasticizer may be present at a weight concentration of from greater than 0 to about 20 parts per hundred parts of the uncured polymer resin. All of the composite ink formulations as well as the epoxy ink used to prepare the data shown in FIGS. 3A and 3B included a small amount of DMMP.

In some cases, a solvent such as acetone may be added to the composite ink formulation. The solvent may be effective in lowering the viscosity of the ink formulation prior to deposition, thereby enabling higher printing speeds and reducing the propensity of the extruded filament to “curl up” against the nozzle during deposition. The solvent may have a concentration of from 0 wt. % to about 20 wt. % in the composite ink formulation.

A number of different types of filler particles may be incorporated into the composite ink formulation for rheology control and/or to influence the mechanical or other (e.g., electrical, thermal, magnetic etc.) properties of the printed composite structure. In one example, the filler particles may be carbon-based, and thus may comprise carbon. For example, the filler particles may comprise silicon carbide particles and/or particles of another carbide, such as boron carbide, zirconium carbide, chromium carbide, molybdenum carbide, tungsten carbide or titanium carbide. It is also envisioned that the filler particles may comprise substantially pure carbon particles. In other words, the filler particles may comprise carbon particles consisting of carbon and incidental impurities. Examples of suitable carbon particles may include diamond particles, carbon black, carbon nanotubes, carbon nanofibers, graphene particles, carbon whiskers, carbon rods, and carbon fibers, which may be carbon microfibers. The filler particles may also or alternatively comprise clay particles, such as clay platelets; oxide particles, such as silica, alumina, zirconia, ceria, titania, zinc oxide, tin oxide, iron oxide (e.g., ferrite, magnetite), and/or indium-tin oxide (ITO) particles; and/or nitride particles, such as boron nitride, titanium nitride, and/or silicon nitride. As one of ordinary skill in the art would recognize, the filler particles may be electrically conductive, semiconducting, or electrically insulating.

TABLE 2
Constituent properties of exemplary filler particles and epoxy resin

| | Modulus | Density | Mor- | Characteristic |
|---|---|---|---|---|
| | (GPa) | (g/cc) | phology | dimensions |
| Epoxy resin | 2.7 | 1.16 | — | — |
| (e.g., Epon 826) | | | | |
| Clay platelets | 170 | 1.98 | platelet | <10 μm |
| (e.g., Cloisite | | | | agglomerates* of |
| nano-clay) | | | | 1 × 100 nm |
| | | | | platelets; |
| SiC whiskers | 450 | 3.21 | rod | 0.65 μm × 12 μm |
| Carbon fibers | 900 | 2.2 | rod | 10 μm × 220 μm |

*Agglomerates may at least partially exfoliate during mixing.

The constituent properties of some exemplary filler particles and epoxy resin are provided in Table 2. Clay platelets are believed to act predominantly as a rheology modifier, imparting the desired shear thinning and shear yield stress to the uncured composite ink formulation, but they also contribute to stiffening of the cured epoxy matrix. The silicon carbide whiskers impart a high storage modulus to the ink formulation, but they may not provide a sufficient shear yield strength for the printed filament to maintain its shape. In small quantities, the carbon fibers may have a small effect on the rheology of the ink formulation. However, high aspect ratio whiskers and fibers, when used, may become highly aligned in the shear and extensional flow field within the nozzle during deposition, as shown schematically in FIG. 2B, and may result in very effective stiffening in the cured composite structure along the direction of printing.

The filler particles may thus include high aspect ratio particles that have aspect ratio of greater than 1, or greater than about 2, where the aspect ratio may be a length-to-width ratio. In some cases, the aspect ratio may refer to a length-to-thickness ratio. If the filler particles are agglomerated, the aspect ratio relevant to the properties of the ink formulation and the printed composite may be the aspect ratio of the agglomerated particles. If the width and the thickness of a particle are not of the same order of magnitude, the term “aspect ratio” may refer to a length-to-width ratio. The filler particles may comprise, for example, whiskers, fibers, microfibers, nanofibers, rods, microtubes, nanotubes, or platelets. At least some fraction of, or all of, the high aspect ratio particles may have an aspect ratio greater than about 2, greater than about 5, greater than about 10, greater than about 20, greater than about 50, or greater than about 100. Typically, the aspect ratio of the high aspect ratio particles is no greater than about 1000, no greater than about 500, or no greater than about 300. Such high aspect ratio particles may be at least partly aligned during 3D printing of the ink formulation, depending in part on the size and aspect ratio of the particles in comparison to the diameter of the deposition nozzle.

The high aspect ratio particles may have at least one short dimension (e.g., thickness and/or width) that lies in the range of from about 1 nm to about 50 microns. The short dimension may be no greater than about 20 microns, no greater than about 10 microns, no greater than about 1 micron, or no greater than about 100 nm. The short dimension may also be at least about 1 nm, at least about 10 nm, at least about 100 nm, at least about 500 nm, at least about 1 micron, or at least about 10 microns.

The high aspect ratio particles may have a long dimension (e.g., length) that lies in the range of from about 5 nm to about 10 mm, and is more typically in the range of about 1 micron to about 5 microns, or from about 100 nm to about 500 microns. The long dimension may be at least about 10 nm, at least about 100 nm, at least about 500 nm, at least about 1 micron, at least about 10 microns, at least about 100 microns, or at least about 500 microns. The long dimension may also be no greater than about about 5 mm, no greater than about 1 mm, no greater than about 500 microns, no greater than about 100 microns, no greater than about 10 microns, no greater than 1 micron, or no greater than about 100 nm.

If the filler particles are substantially isotropic particles, then they may have an aspect ratio of about 1 and a linear size (e.g., diameter) that lies within any of the above-described ranges.

The composite ink formulation and the printed composite structure may include filler particles of more than one type, size and/or aspect ratio, allowing for optimization of the rheology of the composite ink formulation as well as enhancement of the mechanical properties of the printed composite structure. For example, the filler particles may comprise a first set of particles added primarily to refine the flow properties of the composite ink formulation, and a second set of particles added primarily to improve the stiffness of the printed composite part. In one example, the second set of particles may include high aspect ratio particles, such as silicon carbide whiskers or carbon fibers, while the first set of particles may be more isotropic in morphology with an aspect ratio lower than the second set of particles, such as clay platelets or oxide particles, which may include agglomerates. The particles (or agglomerates) of the first set may have, for example, an aspect ratio in the range of about 1 to about 4, and the particles of the second set may have an aspect ratio of about 5 to about 20 (e.g., at least about 10, or at least about 15). The aspect ratio of the particles of the second set may also be greater than 20, greater than 50, or greater than 100, for example.

It should be noted that when a set of particles—or more generally speaking, more than one particle—is described as having a particular aspect ratio, size or other characteristic, that aspect ratio, size or characteristic can be understood to be a nominal value for the plurality of particles, from which individual particles may have some deviation, as would be understood by one of ordinary skill in the art.

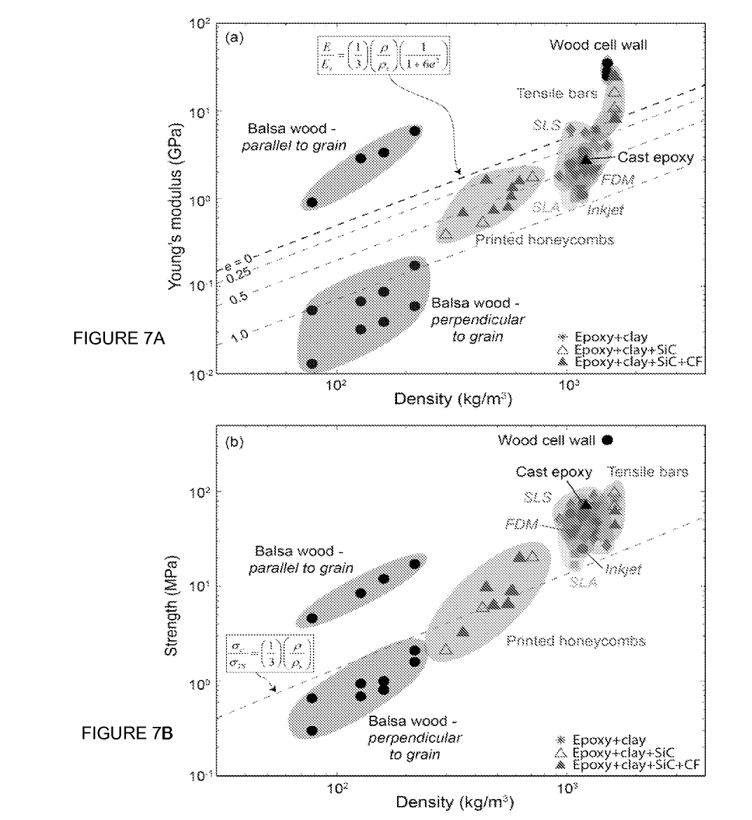

The filler particles may further comprise a third set of particles having a different chemical composition, size and/or aspect ratio from each of the first and second sets of particles. FIGS. 3A and 3B show an exemplary shear-thinning, high-yield stress epoxy ink formulation including three different sets of particles (clay platelets, silicon carbide whiskers and carbon fibers) that can be used to produce a printed composite structure having anisotropic mechanical properties and an extremely high Young's modulus (see FIG. 7A, which is discussed further below). It is contemplated that the composite ink formulation may include up to 5 different sets of particles, where the particles of each set differ from the particles of the other sets based on their composition, size and/or aspect ratio. Assuming the rheological requirements are met, the number and amount of different types of particles may be tuned to optimize the properties of the printed composite part.

It should be noted that the particles of the first, second, third and/or higher sets may have a chemical composition, size and/or aspect ratio as described in any of the examples and embodiments in this disclosure. Also, as would be recognized by one of ordinary skill in the art, particles of one set are physically intermixed with particles of the other set(s) in the composite ink formulation. In fact, it is typically advantageous to have a homogeneous mixture of all of the types of particles.

It is beneficial to control the relative amounts of the various types of filler particles to optimize the mechanical properties of the printed composite structure without sacrificing the rheological properties of the composite ink formulation. Exemplary concentration ranges are provided in Table 3 below.

TABLE 3
Exemplary ranges of possible composite ink constituents

| | | Exemplary | Preferred |
|---|---|---|---|
| | | Concen- | Concen- |
| | | trations | trations |
| Possible Ink Constituents | Examples | (wt. %) | (wt. %) |
| Polymer resin | Epoxy resin | 30-95 | 40-60 |
| Solvent | Acetone | 0-20 | 0-2 |
| Antiplasticizer | DMMP | 0-15 | 0-5 |
| Latent curing agent | VS03 | 0-10 | 2-4 |
| Filler particles | Clay platelets | 5-50 | 10-30 |
| (e.g., AR* from about 1-4) | | | |
| Filler particles | SiC whiskers | 0-50 | 10-30 |
| (e.g., AR from about 5-20) | | | |
| Filler particles | Carbon fibers | 0-40 | 2-10 |
| (e.g., AR > 20) | | | |

*AR = aspect ratio

As set forth above, the composite ink formulation may include the polymer resin at a concentration of from about 30 wt. % to about 95 wt. %. For example, the concentration of the polymer resin in the composite ink formulation may be at least about 30 wt. %, at least about 40 wt. %, at least about 50 wt. %, at least about 60 wt. %, at least about 70 wt. %, or at least about 80 wt. %. The concentration of the polymer resin in the composite ink formulation may also be no greater than about 95 wt. %, no greater than about 90 wt. %, no greater than about 80 wt. %, no greater than about 70 wt. %, or no greater than about 60 wt. %.

The concentration of the filler particles in the composite ink formulation may be at least about 5 wt. %, at least about 10 wt. %, at least about 20 wt. %, at least about 30 wt. %, at least about 40 wt. %, at least about 50 wt. %, at least about 60 wt. %, or at least about 70 wt. %. The concentration of the filler particles may also be no greater than about 70 wt. %, no greater than about 50 wt. %, no greater than about 30 wt. %, no greater than about 20 wt. %, or no greater than about 10 wt. %. In terms of volume fraction, the amount of the filler particles may be at least about 5 vol. %, at least about 10 vol. %, at least about 20 vol. %, at least about 30 vol. %, at least about 40 vol. %, or at least about 50 vol. %. The amount may also be no greater than about 60 vol. %, no greater than about 50 vol. %, no greater than about 40 vol. %, no greater than about 30 vol. %, or no greater than about 20 vol. %.

The latent curing agent may be present in the ink formulation at a concentration of greater than 0 wt. %, such as about 0.1 wt. % or greater, about 1 wt. % or greater, or about 2 wt. % or greater. The concentration of the latent curing agent may also be as high as about 10 wt. %, as high as about 5 wt. %, or as high as about 3 wt. %. Specified in terms of weight relative to the weight of the uncured polymer resin, the latent curing agent may be present at a weight concentration of greater than about 2 parts, greater than about 4 parts, greater than about 8 parts, or greater than about 12 parts per hundred of the uncured polymer resin, and up to about 15 parts per hundred of the uncured polymer resin.

The antiplasticizer, which is optional, may be present in the composite ink formulation at a concentration of up to about 15 wt. %, or up to about 10 wt. %. For example, the concentration of the antiplasticizer may be from about 2 wt. % to about 8 wt. %. Specified in terms of weight relative to the weight of the uncured polymer resin, the antiplasticizer may be present at a weight concentration of greater than about 2 parts, greater than about 4 parts, greater than about 8 parts, greater than about 12 parts, or greater than about 16 parts per hundred of the uncured polymer resin, and up to about 20 parts per hundred of the uncured polymer resin.

### 3D Printed Composite Structures: First Examples

Lightweight and high-stiffness composite structures, such as cellular structures inspired by natural materials such as wood, may be 3D printed from the composite ink formulations described above. Representative examples of various cellular structures—including square, hexagonal and triangular honeycomb structures—that can be formed by 3D printing are shown in FIGS. 2C-2F, where the scale bars are 2 mm. The cellular structures may be aperiodic or periodic, like the honeycomb structures shown here. Methods of forming 3D printed composite structures, including cellular structures and microlattice structures, are described in detail below.

A 3D printed cellular structure may comprise a cellular network of cell walls separating empty cells, where the cell walls comprise a polymer composite including filler particles dispersed in a polymer matrix (e.g., a thermoset polymer matrix). The filler particles may comprise high aspect ratio particles that have a predetermined orientation within the cell walls. For example, the filler particles may be at least partially aligned with the cell walls along a length thereof.

Because the printed composite structure may be fabricated from a continuous filament in a layer by layer deposition process, each cell wall may have a size and shape defined by a stack of layers of the continuous filament. The length of the cell walls may align with the direction of printing or print path, which may be referred to as a “length direction.” The height of the cell walls may correspond approximately to the average diameter of the continuous filament multiplied by the number of layers in the stack, assuming no settling occurs. A “height direction” may be substantially perpendicular to the length direction.

High aspect ratio particles may be understood to be “at least partially aligned” with the longitudinal axis of the continuous filament (or the cell walls of the cellular network) if at least about 25% of the high aspect ratio particles are oriented such that the length or long axis of the particle is within about 40 degrees of an imaginary line extending along the longitudinal axis of the continuous filament (or along the length of each cell wall, or along the length direction). This imaginary line may also coincide with the print direction or print path. In some cases, the long axis of at least about 30%, at least about 35% or at least about 40% of the high aspect ratio particles may be oriented within about 40 degrees of the imaginary line.

The high aspect ratio particles may be understood to be “highly aligned” with the longitudinal axis of the continuous filament (or the cell walls of the cellular network) if at least about 50% of the high aspect ratio particles are oriented such that the length or long axis of the particle is within about 40 degrees of an imaginary line extending along the longitudinal axis of the continuous filament (or along the length of each cell wall, or along the length direction). This imaginary line may also coincide with the print direction or print path. In some cases, the long axis of at least about 60%, at least about 70%, at least about 80%, or at least about 90% of the particles may be oriented within about 40 degrees of the imaginary line.

Depending on the high aspect ratio particles used and the processing conditions, it may be possible to produce printed composite structures having at least about 25% of the high aspect ratio particles oriented such that the length or long axis of the particle is within about 20 degrees of the imaginary line described above, or within about 10 degrees of the imaginary line. In some cases, at least about 30%, at least about 40%, at least about 50%, at least about 60%, at least about 70%, at least about 80%, or at least about 90% of the particles may have a long axis oriented within about 20 degrees or within about 10 degrees of the imaginary line.

The above-described partial or high alignment of the high aspect ratio particles with respect to the longitudinal axis of the continuous filament (or the length of the cell wall, or the length direction) may occur over an entire length of the continuous filament or cell wall(s), or over only a portion of the length (e.g., over a given distance or cross-section).

Like the composite ink formulation from which it is formed, the polymer composite can include more than one type and size of filler particle. Accordingly, the degree of alignment may be different for different sets of particles. The degree of alignment may depend in part on the aspect ratio of the particles. For example, particles that have an aspect ratio of about 1 or slightly greater than 1 may not be substantially aligned along the longitudinal axis of the continuous filament during printing. On the other hand, particles with an aspect ratio of greater than 10 or 20 may be highly aligned. A large factor in determining the degree of alignment is the length of the particles relative to the diameter of the nozzle. It is believed that particles having a length that is at least about 5% of the diameter of the nozzle may be particularly well suited to being aligned during printing, assuming that clogging of the nozzle can be avoided. For this reason, it may be advantageous for the particles to have both a length that is at least about 5% of the diameter of the nozzle and a large aspect ratio, such as an aspect ratio greater than about 10. The particles may also have a length that is at least about 10%, at least about 20%, at least about 30%, at least about 40%, or at least about 50% of the diameter of the nozzle, and the length of the particles is ideally no longer than about 200% or about 300% of the diameter of the nozzle.

The filler particles (or “high aspect ratio particles” or “particles”) of the polymer composite can have any of the characteristics (composition, size, aspect ratio, concentration, etc.) described above for the filler particles of the composite ink formulation. As one of ordinary skill in the art would recognize, the filler particles of the polymer composite are the same as the filler particles of the composite ink formulation.

The polymer matrix of the polymer composite may comprise a thermosetting polymer such as epoxy, polyurethane, polyimide, polydimethylsiloxane (PDMS), or polyester. It is also contemplated that the polymer matrix may comprise a thermoplastic polymer, as described further below.

The polymer composite may be fabricated by the following process: a continuous filament, which comprises a composite ink formulation including an uncured polymer resin, filler particles, and a latent curing agent, is deposited on a substrate in a predetermined pattern layer by layer. The filler particles include high aspect ratio particles that may be at least partially aligned along a longitudinal axis of the continuous filament when deposited. The composite ink formulation may be cured, preferably after deposition, to form the polymer composite, where the high aspect ratio particles have a predetermined orientation therein. The resulting 3D printed composite structure may have any size and shape that can be formed by depositing a continuous filament and curing, as described above. The composite structure may be a substantially fully dense solid or a porous structure comprising voids or porosity.

For example, the 3D printed composite structure may be a cellular structure, as shown in FIGS. 2C-2F. In such a case, the cellular structure (or cellular network) may take the form of a honeycomb structure having from 3 to 6 cell walls surrounding each cell. As mentioned above, each cell wall may be defined by a stack of one or more extruded filaments deposited layer-by-layer on a substrate as a continuous filament.

The thickness of each cell wall may be determined by the diameter of the continuous filament, which may be influenced by the size of the nozzle as well as the deposition pressure and speed. The continuous filament may have a substantially cylindrical shape as a consequence of being extruded through the nozzle. The thickness of each cell wall may be in the range of from about 20 microns to about 20 mm, and is more typically from about 100 microns to about 500 microns. The length of each cell wall may range from 0.5 mm to about 50 mm. As shown in FIGS. 2C-2F for the honeycomb structures, the cell walls may follow a linear path. However, due to the flexibility of the fabrication method, one or more of the cell walls of the cellular network may alternatively follow a curved or curvilinear path. For example, one or more curved walls may surround each cell.

Given the high rest storage modulus and shear yield strength of the continuous filament, the cell walls may be built to heights of up to 100 layers (e.g., from 2 layers to 100 layers). The height of each of the cell walls may depend on the size of the continuous filament and the number of layers. Generally speaking, the maximum height may be up to about 100 times the thickness of the cell wall. For example, the height may be at least about 5 times, at least about 10 times, at least about 20 times, at least about 50 times, or at least 80 times the thickness of the cell wall.

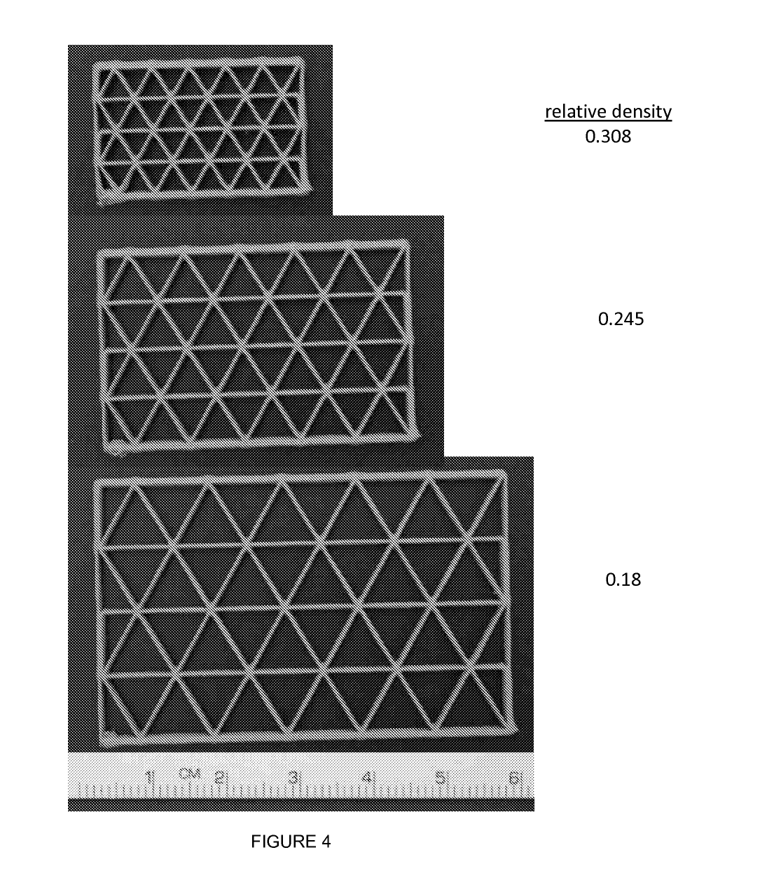

Relative density may be defined as the density of the cellular structure relative to the density of the polymer composite making up the cell walls. Using a composite ink formulation engineered to provide good rheological properties as well as to form a polymer composite exhibiting high stiffness and strength, the length of the cell walls and size of the cells may be increased to minimize the relative density of the cellular structure. As illustrated in FIG. 4, the relative density of the cellular structure may be as low as about 0.1, and it may also be no more than about 0.4, no more than about 0.3, or no more than about 0.2. The polymer composite may have a density in the range of from about 1300 g/cm³ to about 1650 kg/m³. Advantageously, a lightweight cellular structure with excellent mechanical properties can be fabricated.

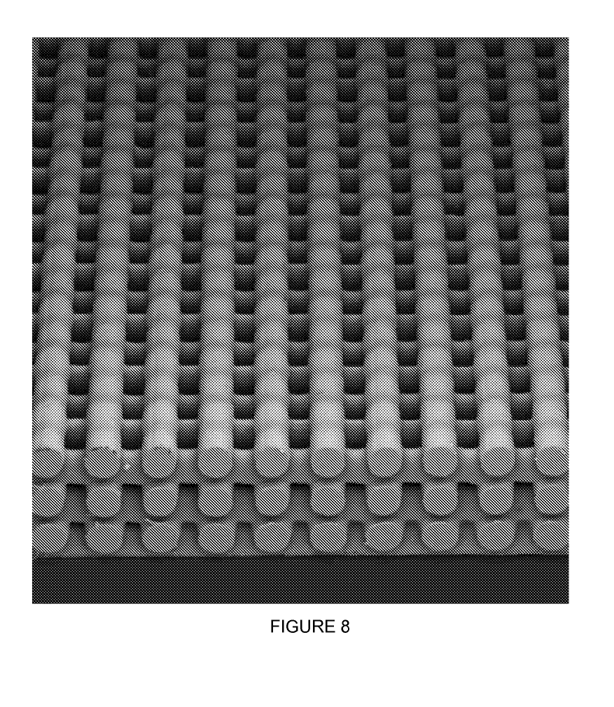

Another example of a 3D printed composite structure is the exemplary microlattice shown in the scanning electron microscope image of FIG. 8, which may be 3D printed from any of the composite ink formulations described above. The exemplary microlattice was printed using a 200 micron-diameter deposition nozzle and includes six layers, where the filaments in a given layer are positioned orthogonal to the filaments in adjacent layers. The filaments of each layer may be portions of a continuous filament deposited as the nozzle is moved in a back and forth pattern across the layer. Upon curing, the 3D printed microlattice comprises a polymer composite that includes filler particles dispersed in a thermoset polymer matrix. In the example of FIG. 8, the 3D printed composite microlattice is formed from an epoxy composite comprising an epoxy matrix and silicon oxide particles.

Generally speaking, a microlattice structure such as that shown in FIG. 8 includes a plurality of layers of filaments arranged in a crisscross pattern that defines 3D network of interconnected voids through the microlattice. Being “arranged in a crisscross pattern” means that each extruded filament above a first layer of the extruded filaments includes spanning portions alternating with crossing portions along a length thereof, where a crossing portion contacts an extruded filament from an underlying layer, and a spanning portion extends between consecutive crossing portions unsupported by an extruded filament from the underlying layer. As with other printed composite structure geometries described herein, the extruded filaments comprise a polymer composite including a polymer matrix and filler particles dispersed therein, where the filler particles may comprise high aspect ratio particles at least partially aligned with the extruded filaments along a length thereof. Typically, the polymer matrix is a thermoset polymer matrix.

Returning to the exemplary cellular structures of FIGS. 2C-2E, the printed structures comprise an epoxy composite that includes two types of filler particles dispersed in an epoxy matrix. The structures were printed by extruding a composite ink formulation comprising an epoxy resin with clay platelets and SiC whiskers (see Table 1) from a non-rotating nozzle of 200 μm diameter. The cell walls of each cellular structure are over 2 mm in height, which corresponds to about 20 layers.

The exemplary cellular structure shown in FIG. 2F (portions of which are shown at a higher magnification in FIGS. 2G and 2H) was printed with a non-rotating nozzle of 410 μm diameter using a composite ink formulation containing clay platelets, SiC whiskers and carbon fibers (see Table 1). The cell walls of this structure are nominally 350 μm in thickness, which corresponds roughly to the diameter of a single filament, and highly aligned carbon fibers are clearly visible within. Remarkably, carbon fibers in excess of 500 μm in length, which is longer than both the cell wall thickness and the nozzle diameter, can be found throughout the cellular structure. Despite the long length of the carbon fibers, the composite ink formulation printed consistently without clogging during the entire investigation, which involved several hours of printing and about 20 cc of the composite ink formulation.

As evidenced by FIGS. 2G and 2H, the polymer composite that forms the cell walls of the cellular structure has a microstructure that is determined at least in part by the printing process. High aspect ratio filler particles dispersed within the polymer matrix may be at least partially or highly aligned with the cell walls during printing. Because alignment of the filler particles occurs naturally along the print direction, the build path itself can be used to spatially control the orientation of any desired anisotropy within the part. For example, reinforcements may be aligned around geometric stress concentrators or stiffness can be graded near fixture points to minimize damage.

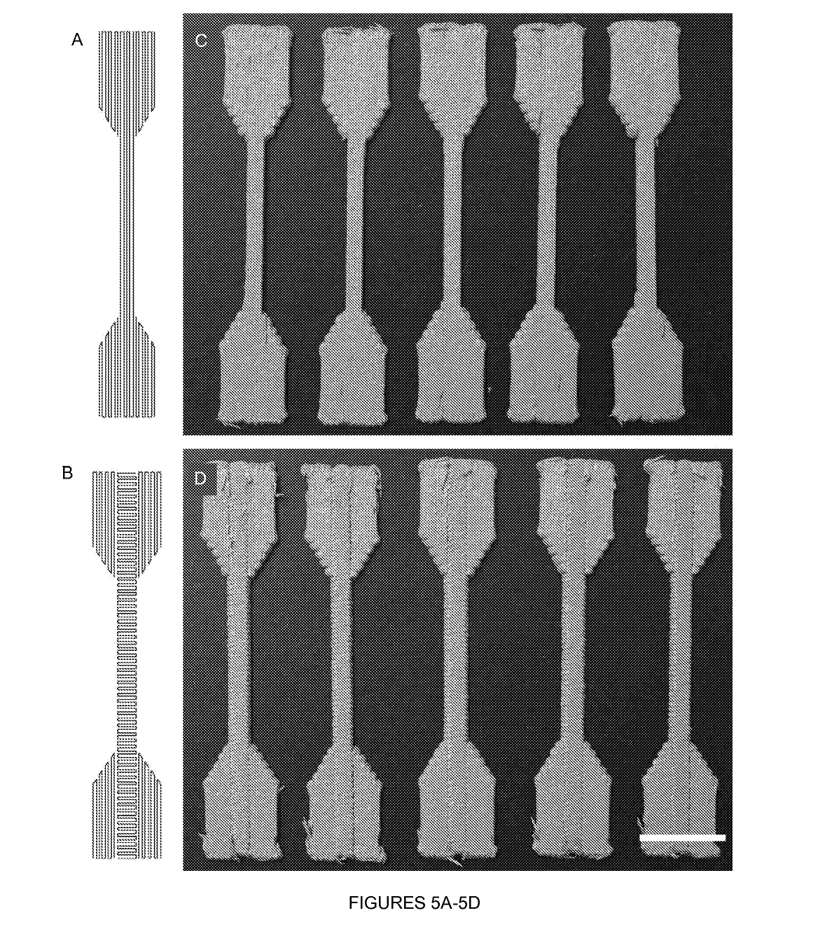

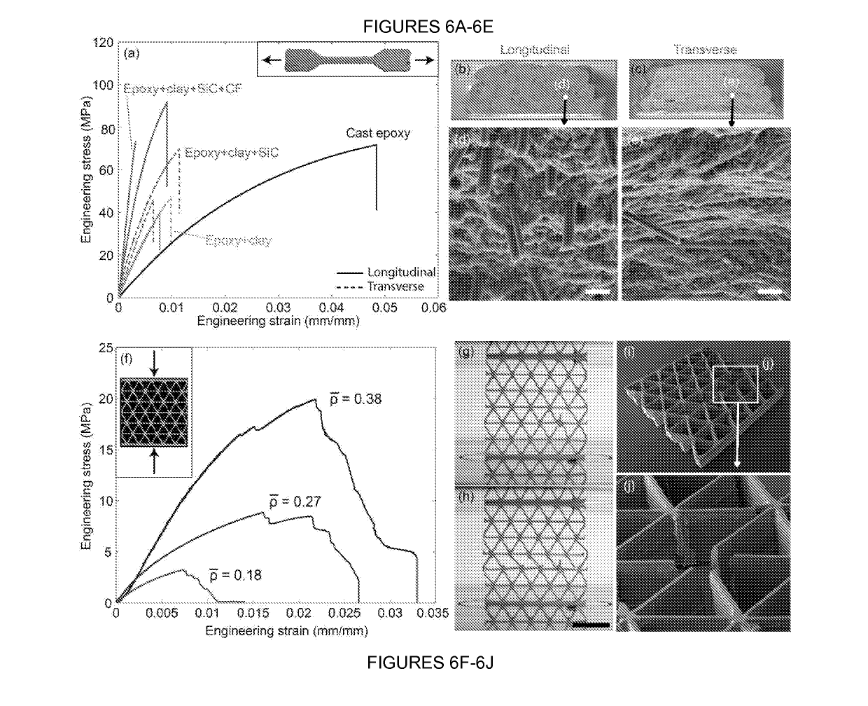

To quantify the mechanical properties of the printed composite structures, printed tensile bars and triangular honeycomb structures were tested on an Instron 5566 load frame in tension and compression, respectively. The effects of build direction were probed by using two separate print paths for the tensile bars, one oriented longitudinally along the tensile direction, and one oriented transverse to the tensile direction, as illustrated in FIGS. 5A-5D. Results of the tensile tests are shown in FIG. 6A along with tensile data for the baseline cast (unfilled) epoxy resin (Epon 826) with DMMP.

The epoxy composites containing SiC whiskers and carbon fiber rods show significant anisotropy and print path dependence due to the high degree of alignment of the fillers during deposition. The printed composite structures show a substantial increase in Young's modulus, E, over the unfilled epoxy resin from 2.66±0.17 GPa to 8.06±0.45 and 10.61±1.38 GPa for the transverse specimens with and without carbon fibers, respectively, and 24.5±0.83 and 16.10±0.03 GPa for the longitudinal specimens with and without carbon fibers, respectively. This represents up to a 9-fold increase in modulus over the cast epoxy.

Failure strength values, σ_{f}, for the printed composite structures are comparable to that of the cast epoxy (71.1±5.3 MPa), with the longitudinal specimens exhibiting somewhat higher strengths (66.2±6.1 and 96.6±13.8 MPa, with and without carbon fiber, respectively) than the transverse specimens for both ink formulations containing rods or whiskers (43.9±4.1 and 69.8±2.9 MPa, with and without carbon fiber, respectively).

The epoxy composite containing only clay platelets displays nearly identical longitudinal and transverse properties (E=5.86±0.62 and 6.23±0.24 GPa and σ_{f}=37.5±5.3 and 47.7±2.7 MPa, for longitudinal and transverse specimens, respectively), indicating isotropic properties independent of build direction. Mechanical properties for all three composite formulations, epoxy reinforced with clay, epoxy reinforced with clay and silicon carbide (SiC), and epoxy reinforced with clay, SiC and carbon fibers (CF), are summarized in Table 4 in comparison with data for a cast epoxy, and plotted in FIGS. 7A-7B.

TABLE 4
Mechanical properties of printed epoxy composites compared to
cast epoxy

| | | | | Standard | Young's | Standard |
|---|---|---|---|---|---|---|
| | Density | | Strength | deviation | modulus | deviation |
| Composition | (kg/m³) | Print path | (MPa) | (MPa) | (GPa) | (GPa) |
| Epoxy (cast) | 1210 | N/A | 71.1 | 5.3 | 2.66 | 0.168 |
| Epoxy + clay | 1340 | transverse | 47.7 | 2.7 | 6.23 | 0.24 |
| | | longitudinal | 37.5 | 5.3 | 5.86 | 0.62 |
| Epoxy + clay + SiC | 1613 | transverse | 69.8 | 2.9 | 10.61 | 1.38 |
| | | longitudinal | 96.6 | 13.8 | 16.10 | 0.026 |
| Epoxy + clay + SiC + CF | 1621 | transverse | 43.9 | 4.1 | 8.06 | 0.45 |
| | | longitudinal | 66.2 | 6.1 | 24.54 | 0.83 |

The printed polymer composites may have a Young's modulus from about 6 GPa to about 25 GPa and a failure strength of from about 40 MPa to about 100 MPa. The Young's modulus may be at least about 10 GPa, at least about 15 GPa, or at least about 20 GPa, and may be up to about 25 GPa or about 30 GPa. The failure strength may be at at least about 60 MPa, at least about 70 MPa, at least about 80 MPa, at least about 90 GPa, and up to about 100 MPa.

Referring to FIGS. 6B-6C, the tensile fracture surfaces do not show any evidence of the original printed filaments, indicating full coalescence of the filaments during deposition and/or curing, and minimal evidence of deposition-related defects (e.g. bubbles, nozzle clogging, or filament debonding). SEM micrographs of the fracture surfaces also highlight the multi-scale reinforcement active in these composites, as can be seen in FIGS. 6D-6E. The alignment of the fillers with printing direction is clearly visible with the large carbon fibers and the small SiC whiskers each showing significant pullout in the longitudinal specimens, and minimal pullout in the transverse specimens. Since pullout is an effective toughening mechanism, one may expect to see significant toughening in the longitudinal direction.

Representative stress-strain data for the honeycomb structures are shown in FIG. 6F for a range of relative densities (0.18-0.38). The curves show incremental load drops which correspond to discrete incremental failure events highlighted in still frames taken from videos of the tests (FIGS. 6G-6H). Failure modes include elastic wall buckling, node rotation, and tensile failure of the cell walls. The site of one such node rotation is shown in the SEM micrographs in FIGS. 6I-6J. Property values for printed honeycombs are plotted in FIGS. 7A-7B.

Scaling laws governing the strength and modulus of these cellular structures are well established and follow the following relationships:

$$\begin{matrix}\frac{E}{{E}_{s}} = {B ( \frac{ρ}{{ρ}_{s}} )}^{b} & ( 0 ) \\ and & \\ \frac{{σ}_{c}}{{σ}_{T S}} = {C ( \frac{ρ}{{ρ}_{s}} )}^{c} & ( 0 )\end{matrix}$$

where Eₛ, σ_{TS}, and ρₛ are the Young's modulus, tensile strength, and density of the base solid material, respectively, and E and σ_{c} are the Young's modulus and strength, respectively, of the cellular structure. For a triangular lattice, B=C=⅓ and b=c=1. These model predictions are also plotted in FIGS. 7A-7B using the data for the formulation containing carbon fibers. It can be seen that the modulus values closely follow the expected linear scaling with density, albeit at roughly half the predicted value, while the strength values generally follow the predicted scaling but with significantly more scatter. The discrepancy between predicted and observed modulus values can be attributed, in part, to geometric imperfections in the lattice structure, including nodal misalignment and waviness in the cell walls, which may be observed in the printed composite structures. The modulus of a triangular honeycomb structure with wavy imperfections in the cell walls may be given by:

$$\frac{E}{{E}_{s}} = ( \frac{1}{3} ) ( \frac{ρ}{{ρ}_{s}} ) ( \frac{1}{1 + 6 {e}^{2}} ) \qquad ( 0 )$$

where e≡w₀/t, and w₀ is the amplitude of waviness and t is the wall thickness. Predictions for reduced modulus values are plotted in FIG. 7A for various values of e, and it can be seen that good agreement is observed for e≈0.5.

To put the properties of the 3D printed polymer composites into context, data for commercially available printed polymers and polymer composites, as well as data for balsa wood and properties of the wood cell wall material alone, are included in FIGS. 7A-7B. The newly developed composites have longitudinal Young's modulus values that are nearly equivalent to wood cell walls, 10 to 20 times higher than most commercial printed polymers, and twice as high as the best printed polymer composites, making these 3D printable composites competitive with wood in terms of absolute stiffness.

When printed into lightweight cellular structures, such as the honeycomb structures shown in FIGS. 2C-2F, the printed composite structures exhibit equivalent modulus values as bulk printed polymers at half the density. Furthermore, because honeycombs can be readily printed in a triangular motif with very high in-plane fiber alignment, in contrast to the approximately hexagonal motif found in wood, the in-plane properties of the printed composites are approximately 3 to 8 times better than the transverse properties (perpendicular to the grain) of balsa wood at the same density, with the added benefit of being isotropic in-plane where wood is not.

3D Printing of Composite Structures without Nozzle Rotation

A method of making a 3D printed composite structure, such as those described above, may include depositing a continuous filament comprising a composite ink formulation on a substrate in a predetermined pattern layer by layer, where the composite ink formulation includes filler particles in a flowable matrix material. For example, the composite ink formulation may include an uncured polymer resin, filler particles, and a latent curing agent. The filler particles may comprise high aspect ratio particles that are at least partially aligned along a longitudinal axis of the continuous filament when deposited. The composite ink formulation may be cured, preferably after deposition, to form a polymer composite comprising the filler particles dispersed in a polymer matrix, where the high aspect ratio particles have a predetermined orientation in the polymer composite. The polymer matrix is typically a thermoset polymer matrix, but may be a thermoplastic polymer matrix in some embodiments.

The method may be employed to fabricate stiff and lightweight structures, such as cellular structures. In one example of cellular structure fabrication, the method may comprise depositing the continuous filament on a substrate in a predetermined pattern layer by layer, as described above, to form stacks or layers of the continuous filament. The filler particles may include high aspect ratio particles that are at least partially aligned along a longitudinal axis of the continuous filament when deposited. The composite ink formulation may be cured to form a polymer composite including the filler particles dispersed in a polymer matrix. Upon curing, the stacks of the continuous filament form cell walls of a cellular structure comprising the polymer composite. The high aspect ratio particles of the polymer composite may be at least partially aligned with the cell walls along a length thereof.

Depending on the characteristics of the filler particles and the size of the nozzle used for deposition, the high aspect ratio particles may also be highly aligned (as opposed to just partially aligned) with the longitudinal axis of the continuous filament and/or the cell walls, where the degree of alignment is as explained above.

The “continuous filament” deposited on the substrate may be understood to encompass a single continuous filament of a desired length or multiple extruded filaments having end-to-end contact once deposited to form a continuous filament of the desired length. In addition, two or more continuous filaments in a given layer of a structure may be spaced apart, as end-to-end contact may not be required. A continuous filament of any length may be produced by halting deposition after the desired length of the continuous filament has been reached. The desired length of the continuous filament may depend on the print path and/or the geometry of the structure being fabricated. Generally speaking, the desired length is at least as large as the inner diameter of the nozzle and may be many times the inner diameter (ID) of the nozzle (e.g., at least about 10·ID, at least about 100·ID, at least about 1000·ID, or at least about 10000·ID).

As shown in FIGS. 2A and 2B, one or more filaments may be extruded from a nozzle where progressive alignment of the high aspect ratio particles can occur prior to deposition of the continuous filament on the substrate. The nozzle may be moving with respect to the substrate during deposition (i.e., either the nozzle may be moving or the substrate may be moving, or both may be moving to cause relative motion between the nozzle and the substrate). In the schematic of FIG. 2B, the nozzle is translating with respect to the substrate, and no rotational motion is occurring.

Curing of the composite ink formulation may be carried out after deposition of the continuous filament. That is, the curing may be carried out only after deposition is completed. For example, when the method is applied to form a cellular structure or network, the curing may be carried out after all of the stacks or layers have been formed. As discussed above, premature curing (e.g., during printing of the continuous filament) may lead to unsatisfactory bonding between adjacent layers, thereby diminishing the mechanical integrity of the 3D printed structure and/or leading to component warpage. Because a latent curing agent is employed in the composite ink formulation, premature curing can be avoided. Generally, the curing may entail heating the composite ink formulation at a temperature of from about 100° C. to about 300° C. The curing may also entail more than one heating step, such as a first heat treatment at a temperature from about 100° C.-150° C. and a second heat treatment at a temperature of from about 200° C.-300° C.

The printed composite structure formed by 3D printing and curing, including the cellular structure and polymer composite comprising the polymer matrix and filler particles, may have any of the characteristics described elsewhere in this disclosure.

The method is applicable to extrusion-based printing processes including direct-write printing, as described above, and fused deposition modeling. In the former case, flow through the nozzle and deposition of the continuous filament may be facilitated by using a composite ink formulation with a strain-rate dependent viscosity (and which may be said to be shear-thinning or viscoelastic). In the latter case, extrusion and deposition may rely on the temperature-dependent flow behavior of a thermoplastic polymer, as discussed in more detail below.

### Experimental Details

Ink Preparation: Composite ink formulations were prepared by incorporating the additives into the epoxy resin via Thinky Planetary Centrifugal Mixer (Thinky USA, Inc., Laguna Hills, Calif.) using 125 mL glass containers and a custom adaptor. Batches started with 30 grams of Epon 826 resin (Momentive Specialty Chemicals, Inc., Columbus, Ohio). 3 grams of DMMP (Sigma Aldrich, St. Louis, Mo.) were added first, followed by 5 minutes of mixing and 2 minutes of defoam cycle in the Thinky. Next, SiC whiskers (SI-TUFF™ SC-050, ACM, Greer, SC 29651) were added in 5 or 10 gram increments, followed by the nano-clay platelets (Cloisite 30b, Southern Clay Products, Inc., Gonzales, Tex. 78629), in 2 gram increments, and, when used, the milled carbon fibers (Dialead K223HM, Mitsubishi Plastics, Inc., Tokyo, Japan), in 1 gram increments. Finally, the ink is allowed to cool to room temperature (the mixing causes significant heating), and then the curing agent, Basionics VS03 (BASF, Ludwigshafen, Germany), was added at 5 parts per hundred, relative to the epoxy resin. When carbon fibers are used, 0.5 g of acetone was added along with the curing agent. Each material addition was followed by 5 minutes of mixing and 2 minutes of defoaming in the Thinky mixer.

Rheology: Rheological properties of the composite ink formulation were characterized using an AR 2000ex Rheometer (TA Instruments, New Castle, Del.) with a 40 mm flat plate geometry and a gap of 500 μm or 1000 μm, when the ink formulation contained carbon fibers. All measurements were preceded by a one minute conditioning step at a constant shear rate of 1/s, followed by a ten minute rest period to allow the ink structure to reform.

Printing: The composite ink formulation was loaded into 3 cc, luer-lock syringes (Nordson EFD, Westlake, Ohio) and centrifuged at 3900 rpm for 10 minutes to remove bubbles. Loaded syringes were then mounted in an HP3 high-pressure adaptor (Nordson EFD) and the assembly was mounted on an Aerotech 3-axis positioning stage (Aerotech, Inc., Pittsburgh, Pa.) for deposition. The ink formulation was driven pneumatically and controlled via an Ultimus V pressure box (Nordson EFD), which interfaces with the Aerotech motion control software. Luer-lock syringe tips (Nordson EFD) were used to dictate filament diameter, and filaments were deposited onto glass slides covered with Bytac®, PTFE-coated aluminum foil (Saint Gobain Performance Plastics, Worcester, Mass.) to prevent adhesion. Print paths for each geometry were written as parameterized g-code scripts and were designed to maximize continuity within each printed layer. Printed composite structures were then pre-cured at 100° C. for 15 hours, cooled, removed from the substrate, and cured for 2 hours at 220° C.

Characterization of Printed Composites: Density measurements on fully cured polymer composites were made using the Archimedes method, and the relative densities of honeycombs specimens were calculated from the measured mass and volume of each specimen. Prior to testing, surfaces of the cellular structures were ground flat to ensure good contact with the compression platens. Printed specimens were tested in an Instron 5566 load frame (Instron, Norwood, Mass.) at a strain rate of about 2×10⁻⁴ 1/s for the tensile and compression specimens, respectively. Strain in the samples was measured using the Instron Advanced Video Extensometer (AVE). Reported tensile properties represent an average of at least three samples.

3D Printing of Composite Structures with Nozzle Rotation

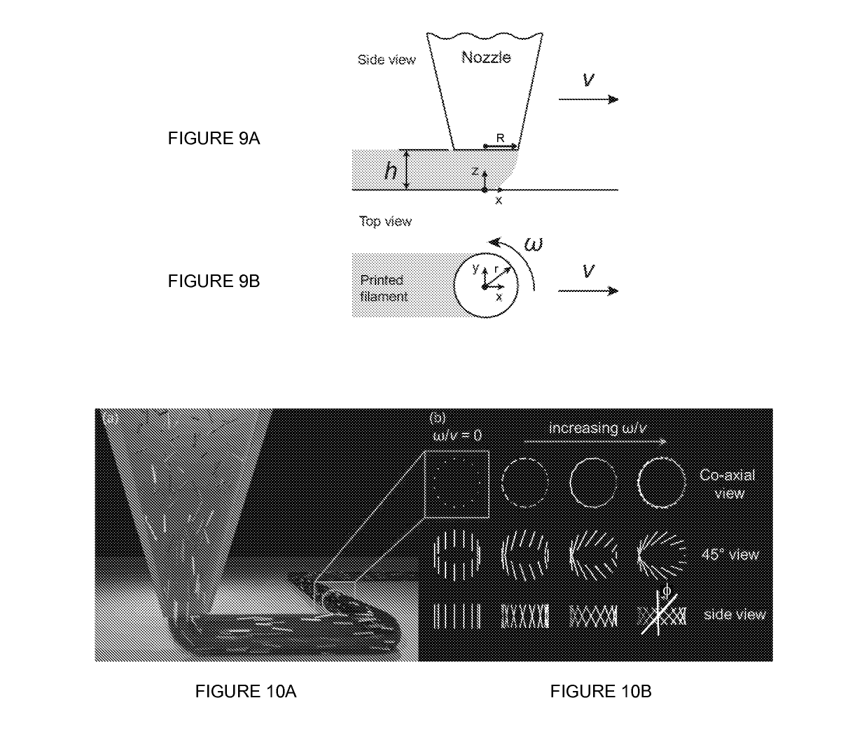

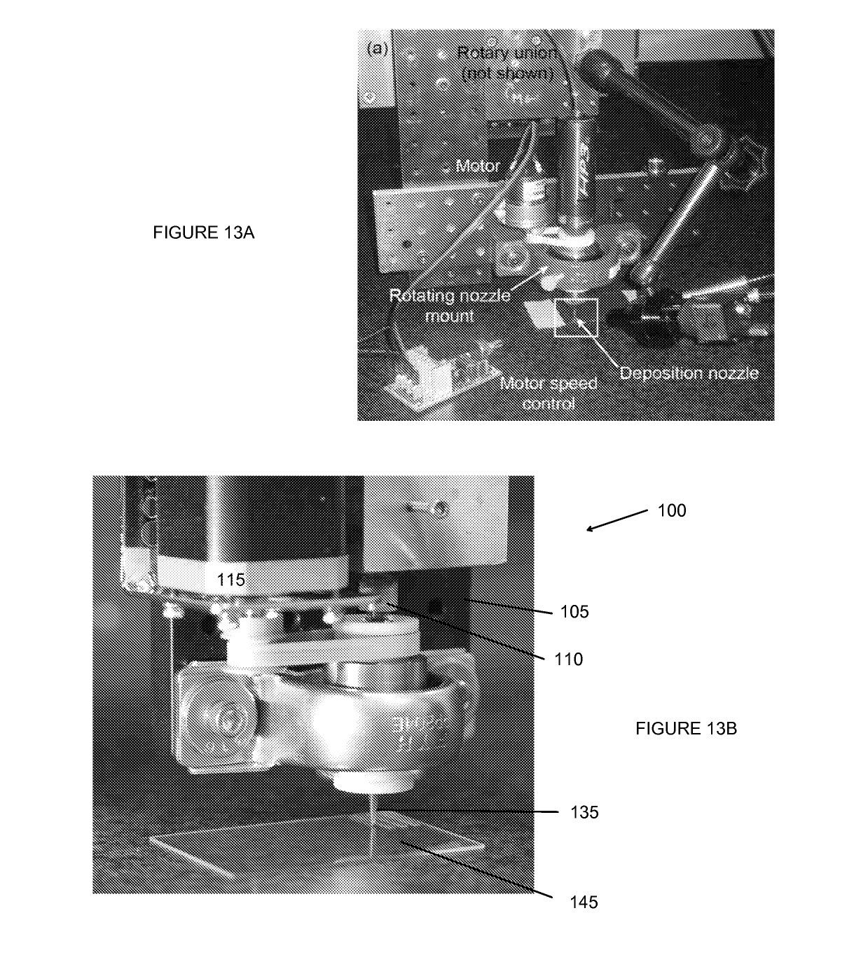

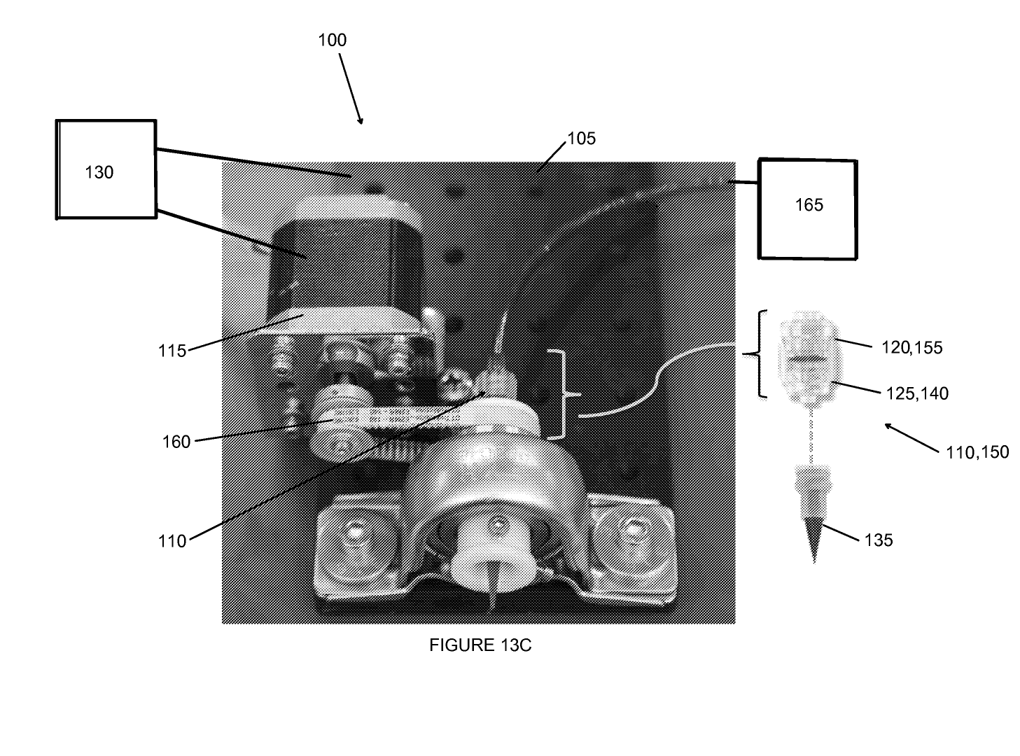

Referring to FIGS. 9A-9B, an alternative embodiment of the method of making a 3D printed composite structure includes extruding a continuous filament from a nozzle that is (a) rotating about a longitudinal axis thereof and (b) translating with respect to a substrate. The translation may occur in an x-, y- or z-direction, where the z-direction is normal to the substrate, or in an arbitrary direction having x, y and/or z components. The continuous filament comprises a composite ink formulation including high aspect ratio particles in a flowable matrix material. The continuous filament is deposited in a predetermined pattern on the substrate, layer by layer. Exemplary rotating nozzles are shown in FIGS. 13A-13C and described below.

At least some fraction of the high aspect ratio particles in the continuous filament have an orientation comprising a circumferential component and a longitudinal component due to the rotational and translational motion of the nozzle, respectively. This orientation is defined with respect to a longitudinal axis of the continuous filament and may be referred to as a helical orientation. Preferably, at least about 40%, at least about 50%, at least about 60%, at least about 70%, at least about 80%, or at least about 90% and up to 100% of the high aspect ratio particles in the continuous filament are helically oriented. The continuous filament may be processed (e.g., cured or cooled) to form a polymer composite comprising a polymer matrix and oriented high aspect ratio particles dispersed therein, as described in greater detail below.

The rotational motion of the nozzle may be controlled independently from the translational motion. The rotation of the nozzle (which may also be referred to as the “nozzle portion”) may occur continuously during translation of the nozzle, or the rotation may occur intermittently during translation of the nozzle. Also or alternatively, the rotational speed of the nozzle may be varied during printing while the translation speed of the nozzle remains the same or is also varied. These approaches may be useful to form continuous filaments having a variation in high aspect ratio particle orientation along the length of the filament, as described further below.

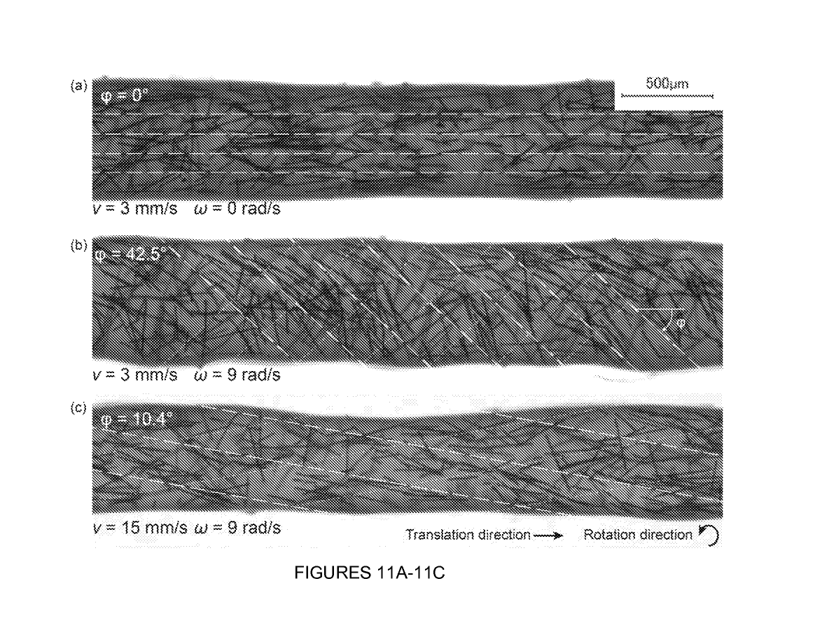

Rotation rates ω of from about 1 rad/s to about 1000 rad/s, and translation speeds (or deposition rates) of from about 1 mm/s to about 500 mm/s are typical. The relative magnitude of the translation speed ν to the rotation rate ω may influence the degree of rotational shear experienced by the composite ink formulation during extrusion, and hence the preferred angle of orientation of the high aspect ratio particles with respect to the longitudinal axis of the continuous filament. This angle of orientation may be referred to as the helical angle φ, where 0°<φ<90° for a non-zero rotation rate ω and translation speed ν, as illustrated in FIGS. 10B and 11A-11C. For example, a high rate of rotation and a low translation speed may result in the alignment of the high aspect ratio particles being dictated predominantly by the rotational shear, with the particles orienting nearly perpendicular to the print direction at any point along the circumference of the continuous filament. Conversely, with a low rotation rate and high translation speed, fiber orientation may be predominantly dictated by the shear field due to translation, and the fibers may align close to the print direction. Since the rotation and/or the translation of the nozzle may be halted during deposition, the high aspect ratio particles within a continuous filament may have any value of φ from 0° to 90°, e.g., 0≦φ≦90°, 0°≦φ<90°, 0°<φ≦90°, or 0°<φ<90° as set forth above.

FIG. 10A is a schematic of a nozzle undergoing only translational motion ν, with ω being equal to zero. By tuning the relative rates of translation and rotation, the fiber orientation can be tuned anywhere between these two limits. Typically, 10°<φ<75°. FIGS. 11A-11C show a top view of exemplary continuous filaments printed at various ω/ν values. Heavy dashed lines show the calculated ideal orientation using Equation (3) defined below with rₘₐₓ=R=0.305 mm. Because the polymer matrix (epoxy in this example) is somewhat translucent, the fibers on the bottom surface are also visible. The calculated orientation for these fibers on the bottom of the filament is indicated by the fine dashed lines.

Influenced by the rotational and translational shear fields during extrusion, the high aspect ratio particles may follow (roughly or precisely) a helical path of helical angle φ along a length of the continuous filament. For example, at least about 40% of the high aspect ratio particles at a radial position rₘₐₓ, where rₘₐₓ is approximately equivalent to an inner radius R of the nozzle, may have a long axis oriented within about 40 degrees of the helical path. Preferably, at least about 50%, at least about 60%, at least about 70%, at least about 80%, or at least about 90% of the high aspect ratio particles at the radial position rₘₐₓ may have a long axis oriented within about 40 degrees of the helical path.

The high aspect ratio particles may also more precisely follow the helical path of helical angle φ along a length of the continuous filament. For example, at least about 40% of the high aspect ratio particles at the radial position rₘₐₓ may have a long axis oriented within about 20 degrees of the helical path. Preferably, at least about 50%, at least about 60%, at least about 70%, at least about 80%, or at least about 90% of the high aspect ratio particles at the radial position rₘₐₓ may have a long axis oriented within about 20 degrees of the helical path.

The above-described helical alignment of the high aspect ratio particles may occur over an entire length of the continuous filament or over only a portion of the length (e.g., over a given distance or cross-section).

As would be recognized by one of ordinary skill in the art, the helical angle φ is a linear function of radial position within the nozzle, with zero shear due to rotation at the center of the nozzle and maximum shear due to rotation at the nozzle perimeter, assuming the rotation occurs about a central longitudinal axis of the nozzle. Also assuming a uniform shear field, the magnitude of the rotational shear rate may be given by

$${\dot{γ}}_{rot} = \frac{r ω}{h} \qquad ( 1 )$$

where r is the radial position, w is the rotation rate, and h is the distance between the substrate and the nozzle. The magnitude of the translational shear rate may be given by

$${\dot{γ}}_{trans} = \frac{v}{h} \qquad ( 2 )$$

where ν is the translation speed. Assuming that the high aspect ratio particles are substantially aligned along the shear direction, this leads to a helical angle given by

$$ϕ = {tan}^{- 1} ( \frac{r ω}{v} ) \qquad ( 3 )$$

In actuality, the theoretical fiber orientation may depend on the shear rate, rheological properties of the ink, particle aspect ratio, particle loading fraction, and shear history of the composite ink formulation, but (3) provides a best case scenario for highly aligned high aspect ratio particles. Because the rotational shear rate depends on r, some fraction of the high aspect ratio particles may orient along the longitudinal axis of the continuous filament at the center, where r=0, and high aspect ratio particles at the perimeter (where r=rₘₐₓ=R) may have the maximum helical angle.

The 3D printing methods described herein (with or without rotational motion of the nozzle) are applicable to extrusion-based printing processes including direct-write printing and fused deposition modeling. In the former case, flow through the nozzle and deposition of the continuous filament may be facilitated by using a composite ink formulation with a strain-rate dependent viscosity (and which may be said to be shear-thinning or viscoelastic). In the latter case, extrusion and deposition may rely on the temperature-dependent flow behavior of a thermoplastic polymer.

In the case of direct-write printing, the flowable matrix material may comprise an uncured polymer resin. The composite ink formulation may further include a latent curing agent to prevent premature curing of the polymer resin (e.g., during deposition), as described above. Typically, curing is activated by heat exposure after the continuous filament has been deposited. Upon curing, a polymer composite comprising a thermoset polymer with oriented high aspect ratio particles dispersed therein may be formed. Suitable composite ink formulations may show a clear dependence of viscosity on shear rate, as described above. Any or all parts of the description of the composite ink formulation as set forth above may be applicable here.

Alternatively, the flowable matrix material may comprise a thermoplastic polymer at an elevated temperature (e.g., above Tₘ), and the polymer composite may be formed by cooling the continuous filament during deposition (e.g., in the case of fused deposition modeling). Suitable thermoplastic polymers may include one or more of acrylonitrile butadiene styrene (ABS), polylactic acid (PLA), ULTEM™, polyether ether ketone (PEEK), polyether ketone ketone (PEKK), Nylon, and polycarbonate (PC). The polymer may be heated to a temperature of between about 100° C. and 400° C. prior to or during extrusion, and cooling may occur at room or elevated temperature as the continuous filament is deposited on the substrate. In this case, the polymer composite that is formed may comprise a thermoplastic polymer matrix with oriented high aspect ratio particles dispersed therein.

Generally speaking, whether the flowable matrix material comprises an uncured polymer resin or a thermoplastic polymer, a filamentary structure extruded from a nozzle as described herein may comprise a continuous filament including filler particles dispersed therein, where at least some fraction of the filler particles in the continuous filament comprise high aspect ratio particles having a predetermined orientation with respect to a longitudinal axis of the continuous filament.

When the nozzle is translating without rotation, the filamentary structure may include high aspect ratio particles that are at least partially aligned along the longitudinal axis of the continuous filament, as defined previously. The high aspect ratio particles may also be highly aligned along the longitudinal axis of the continuous filament.

When the nozzle is translating and rotating, the filamentary structure extruded from the nozzle may be described as a continuous filament including high aspect ratio particles dispersed therein, where at least some fraction of the high aspect ratio particles have a helical orientation comprising a circumferential component and a longitudinal component with respect to a longitudinal axis of the continuous filament. The circumferential component is imparted by rotation of a deposition nozzle and the longitudinal component is imparted by translation of the deposition nozzle.

The continuous filament may have a generally cylindrical shape due to extrusion through the deposition nozzle, although deviations from a perfectly cylindrical shape are possible due to settling of the continuous filament after deposition and/or use of a nozzle having a non-circular cross-section.

The continuous filament may have any or all of the features described elsewhere in this disclosure. For example, at least about 40%, at least about 50%, at least about 60%, at least about 70%, at least about 80%, or at least about 90% and up to 100% of the high aspect ratio particles in the continuous filament may be helically oriented (in the case of nozzle rotation) or may be oriented such that the long axis of the particle is within about 40 degrees of the longitudinal axis of the continuous filament (when there is little or no nozzle rotation). The continuous filament may comprise a composite ink formulation having any or all of the features described elsewhere in this disclosure. For example, the continuous filament may comprise a thermoplastic polymer or an uncured polymer resin with the high aspect ratio particles dispersed therein, as described above.

### 3D Printed Composite Structures

### Second Examples

A 3D printed composite structure may comprise a polymer composite including a polymer matrix and oriented high aspect ratio particles dispersed therein, where the polymer composite is made by extruding a continuous filament from a nozzle while the nozzle rotates about a longitudinal axis thereof and translates with respect to a substrate. The continuous filament may comprise a composite ink formulation including high aspect ratio particles in a flowable matrix material. The continuous filament may be deposited in a predetermined pattern on the substrate, where at least some fraction of the high aspect ratio particles in the continuous filament have an orientation comprising a circumferential component due to rotation of the nozzle and a longitudinal component due to translation of the nozzle. The continuous filament may be further processed to form the polymer matrix with oriented high aspect ratio particles dispersed therein. The processing may comprise curing or cooling. Any of the composite ink formulations set forth anywhere in this disclosure may be employed to form the 3D printed composite structure.

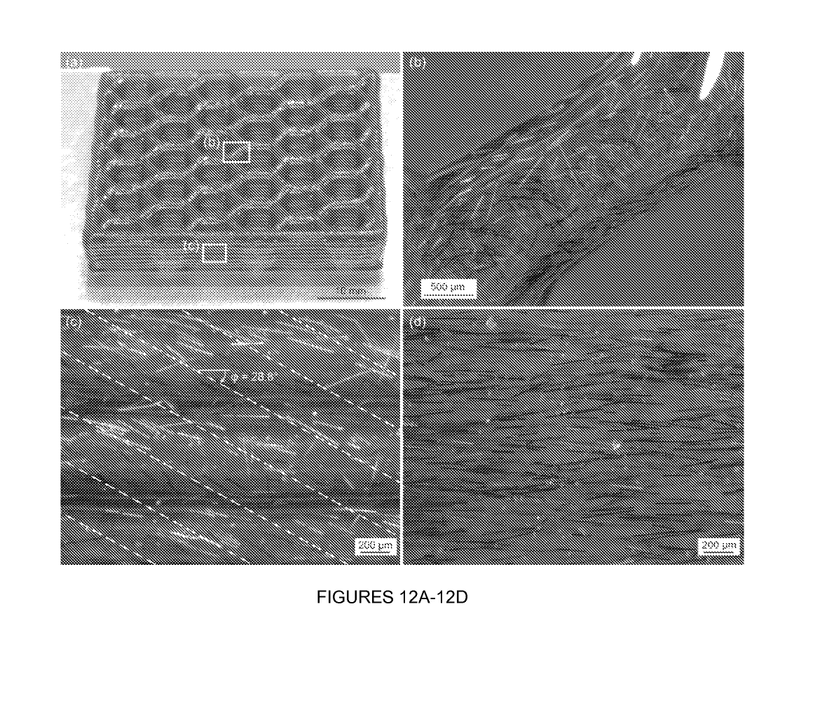

The continuous filament may be deposited layer by layer to form a stack of layers of the continuous filament. The stack of layers may form a dense solid or a porous structure comprising one or more pores or cells. For example, the stack of layers may define a cellular structure comprising a network of cell walls separating empty cells, as shown for example in FIG. 12A.

Because the printed composite structure is fabricated from a continuous filament in a layer by layer deposition process, each cell wall may have a size and shape defined by a stack of layers of the continuous filament. The length of the cell walls may align with the direction of printing or print path. The height of the cell wall may correspond approximately to the average diameter of the continuous filament multiplied by the number of layers in the stack.

When a continuous filament is stacked up layer by layer, the high aspect ratio particles on an upper surface of a bottom layer may be oriented at +φ with respect to the print direction, while high aspect ratio particles on a lower surface of the adjacent upper layer may be oriented at −φ with respect to the print direction. This leads to a situation akin to traditional laminate composites with +/−φ layups. At the same time, high aspect ratio particles on the left and right “sides” of the continuous filament may be oriented at an angle φ from the horizontal, thus achieving out-of-plane fiber orientation. By directing particle orientation in this fashion and integrating variable nozzle rotation with translation, printed composites may be able to achieve previously unattainable properties, including higher strength and stiffness in the z-direction (or the “height direction” of a stack of filaments), tailored shear moduli in printed cellular structures, spatial gradients in fiber orientation, and, potentially, fully isotropic properties with fiber reinforcement.

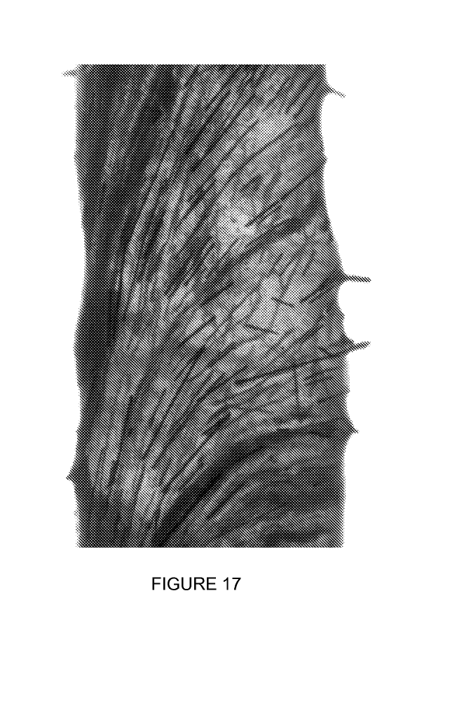

As explained above, a high rate of rotation and a low translation speed may result in the alignment of the high aspect ratio particles being dictated predominantly by the rotational shear, with the particles orienting nearly perpendicular to the print direction (e.g., close to the height direction) at any point along the circumference of the continuous filament. At sufficiently high rates of rotation and translation, the high aspect ratio particles may protrude from the continuous filament, as shown in FIG. 17 and discussed in more detail below. Alternatively, with a low rotation rate and high translation speed, high aspect ratio particle orientation may be predominantly dictated by the shear field due to translation, and the high aspect ratio particles may align closer to the print direction.

Thus, depending on the rotational component of the nozzle motion relative to the translational component, at least about 20% of the high aspect ratio particles in the 3D printed composite structure may have a long axis oriented within about 80 degrees of a height direction of the stack of layers (or the cell walls, if the 3D printed composite structure is a cellular or honeycomb structure as described above). Preferably, at least about 30%, at least about 40%, at least about 50%, or at least about 60% of the high aspect ratio particles may have a long axis oriented within about 80 degrees of the height direction of the stack of layers or the cell walls. The height direction may be understood to be parallel to the z-direction as defined above.

Accordingly, a 3D printed cellular structure may comprise a network of cell walls separating empty cells, where the cell walls comprise a polymer composite including high aspect ratio particles dispersed in a polymer matrix, and where at least about 20% of the high aspect ratio particles have a long axis oriented within about 80 degrees of a height direction of the cell walls.

Because the relative rates of rotation and translation of the nozzle are controllable, the particles may be more highly oriented in the height direction. For example, at least about 20%, at least about 30%, at least about 40%, at least about 50%, at least about 60%, or at least about 80% of the oriented high aspect ratio particles may have a long axis oriented within about 60 degrees of the height direction of the stack of layers (or the cell walls of a cellular structure). It is also contemplated that a considerable volume fraction of the high aspect ratio particles may have a long axis oriented within about 40 degrees of the height direction of the stack of layers or the cell walls. For example, at least about 20%, at least about 30%, at least about 40%, at least about 50%, or at least about 60% of the oriented high aspect ratio particles may have a long axis oriented within about 40 degrees of the height direction of the stack of layers or the cell walls.

Again, depending on the rotational component of the nozzle motion relative to the translational motion, the high aspect ratio particles in the stack of layers or cell walls may be even more highly oriented in the height direction (e.g., within about 20 degrees of the height direction). For example, at least about 20%, at least about 30%, at least about 40%, at least about 50%, at least about 60%, or at least about 80% of the oriented high aspect ratio particles may have a long axis oriented within about 20 degrees of the height direction of the stack of layers or the cell walls.

The above-described alignment of the high aspect ratio particles may occur over an entirety of the stack of layers or cell walls, or over only a portion thereof (e.g., over a given layer or cross-section).

Achieving a controlled out-of-plane orientation of the high aspect ratio particles during deposition of the continuous filament, as described herein, may allow composites with improved mechanical properties to be fabricated.

### Characterization and Testing: Exemplary Results A

To test the 3D printing apparatus shown in FIG. 13A and described below, several continuous filaments of a carbon fiber-reinforced epoxy-based ink are printed at various rates with and without rotation. Representative filaments are shown in FIGS. 11A-11C, which provide evidence of the strong effects of nozzle rotation. At zero rotation, fibers are predominantly aligned with the filament direction, with some degree of random scatter. When printed at the same translational speed with added rotation, the fibers preferentially align at a large angle to the filament axis. When printed at the same rotation rate, but a higher translational speed, the fibers align at a shallow angle to the filament axis. Overlayed on the filaments are dashed lines to indicate the predicted orientation based on Equation (3). The agreement with experimental orientation appears to be reasonable, although there is some scatter and Equation (3) is an idealized prediction.

To demonstrate out-of-plane orientation (e.g., in the height direction or z-direction), a hexagonal honeycomb structure is printed 5 mm high (approximately 18 layers) using the rotating nozzle. The cellular structure is shown in FIG. 12A with magnified views of both the top of the printed filaments (FIG. 12B) and the cell wall of the structure (FIG. 12C). In the cell wall, the fiber orientation is close to that predicted by Equation (3), 28.8°. For comparison, the cell wall of a honeycomb printed without using the rotating nozzle is also shown in FIG. 12D. Here the fibers can be seen to orient predominantly in the plane of printing (x-y plane), which is horizontal in the image.

### Experimental Details

Ink Preparation: Exemplary composite ink formulations are prepared by mixing an epoxy resin (Epon 826 epoxy resin, Momentive Specialty Chemicals, Inc., Columbus, Ohio) with appropriate amounts of dimethyl methyl phosphonate (DMMP, Sigma Aldrich, St. Louis, Mo.), nano-clay platelets (Cloisite 30b, Southern Clay Products, Inc., Gonzales, Tex.), and milled carbon fibers (Dialead K223HM, Mitsubishi Plastics, Inc., Tokyo, Japan) using a Thinky Planetary Centrifugal Mixer (Thinky USA, Inc., Laguna Hills, Calif.) in a 125 mL glass container using a custom adaptor. An imidazole-based ionic liquid is employed as a latent curing agent (Basionics VS03, BASF Intermediates, Ludwigshafen, Germany). Batches start with 30 grams of Epon 826 resin. 3 grams of DMMP are added first, followed by 2 minutes of mixing in the Thinky. Next, the milled carbon fibers are added in 1 gram increments. Each material addition is followed by 3-5 minutes in the Thinky mixer. Finally, the ink formulation is allowed to cool to room temperature prior to the addition of the curing agent, Basionics VS03, at 5 parts per hundred by weight, relative to the epoxy resin. After the addition of the curing agent, the composite ink formulation is mixed for 3 minutes.

3D Printing: An exemplary composite ink formulation is loaded into 3 cc, luer-lock syringes (Nordson EFD, Westlake, Ohio) and centrifuged at 3900 rpm for 10 minutes to remove bubbles. Loaded syringes are then mounted in an HP3 high-pressure adaptor (Nordson EFD) in the rotating nozzle mount, and the assembly is mounted on an Aerotech 3-axis positioning stage (Aerotech, Inc., Pittsburgh, Pa.) for deposition. The nozzle is rotated using a JameCo electric motor, part number 164786 (JameCo Electronics, Belmont, Calif.). The composite ink formulation is was driven pneumatically and controlled via an Ultimus V pressure box (Nordson EFD), which interfaces with the Aerotech motion control software. Luer-lock syringe tips (Nordson EFD) are used to dictate filament diameter, and a continuous filament is deposited onto glass slides covered with Bytac®, PTFE-coated aluminum foil (Saint Gobain Performance Plastics, Worcester, Mass.) to prevent adhesion. The print path for a cellular structure having a honeycomb geometry is written as parameterized g-code scripts, and are designed to maximize continuity within each printed layer. Printed composite structures are pre-cured at 100° C. for 15 hours, cooled, removed from the substrate, and cured for 2 hours at 220° C.

### Characterization and Testing: Exemplary Results B

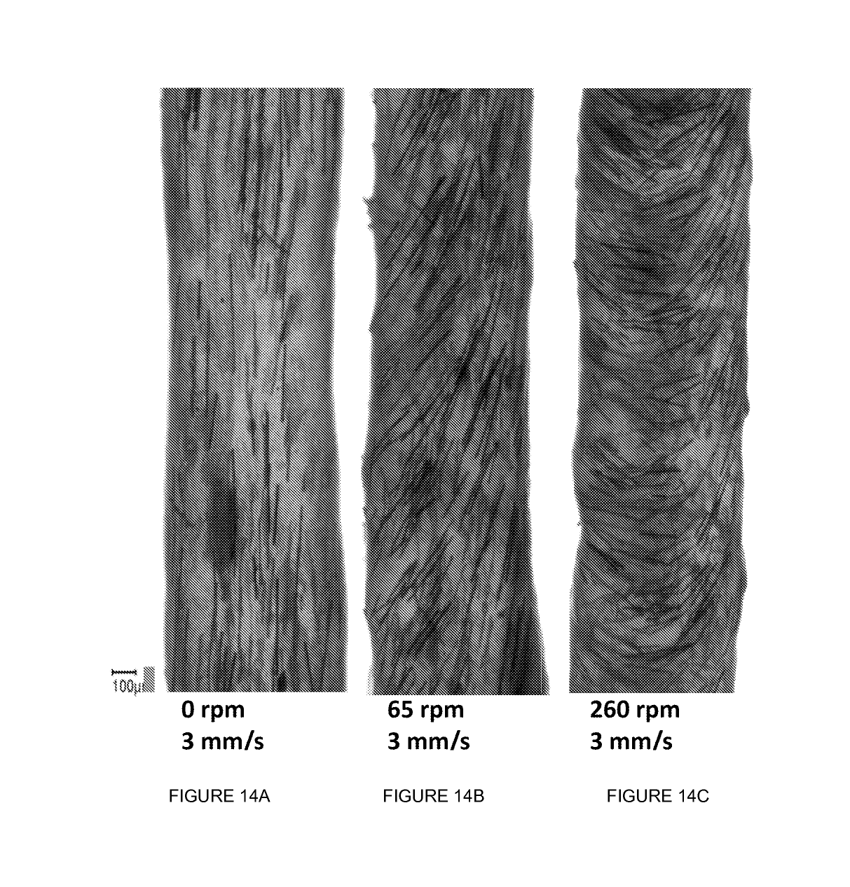

To test the 3D printing apparatus shown in FIGS. 13B-13C and described below, several continuous filaments of a carbon fiber-reinforced epoxy-based ink are printed at various rates with and without rotation. Representative filaments are shown in FIGS. 14A-14C, which provide evidence of the strong effects of nozzle rotation. Referring to FIG. 14A, at zero rotation and a translation speed of 3 mm/s, the fibers are predominantly aligned with the filament direction, with some degree of random scatter. When printed at the same translational speed with added rotation, the fibers preferentially align at an angle to the filament axis (the helical angle φ described above). Comparing FIGS. 14B and 14C, which show filaments printed at a translation speed of 3 mm/s and rotation speeds of 65 rpm (390 deg/s or about 6.8 rad/s) and 260 rpm (1600 deg/s or about 27.9 rad/s), respectively, it can be seen that the helical angle φ increases with rotation speed.

Rotation rates may range from greater than 0 deg/s to 3000 deg/s with the current motor (or about 0 to 52.4 rad/s). Depending on the desired fiber alignment and the translation speed of the nozzle, the rotation rate may be at least about 10 deg/s, at least about 100 deg/s, at least about 200 deg/s, at least about 300 deg/s, at least about 500 deg/s, at least about 700 deg/s, or at least about 1000 deg/s. Typically, the rotation rate is no more than about 3000 deg/s, no more than about 2500 deg/s, or no more than about 2000 deg/s.

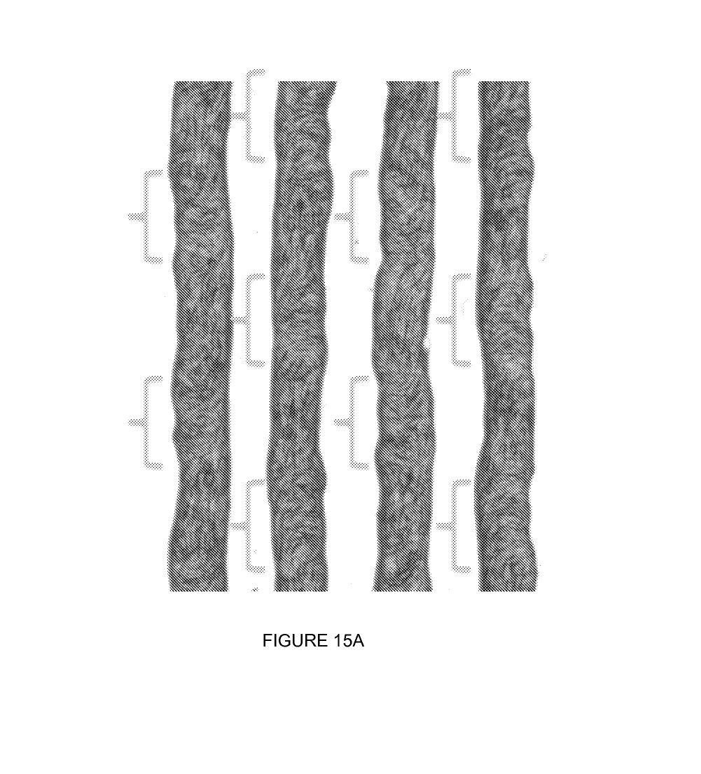

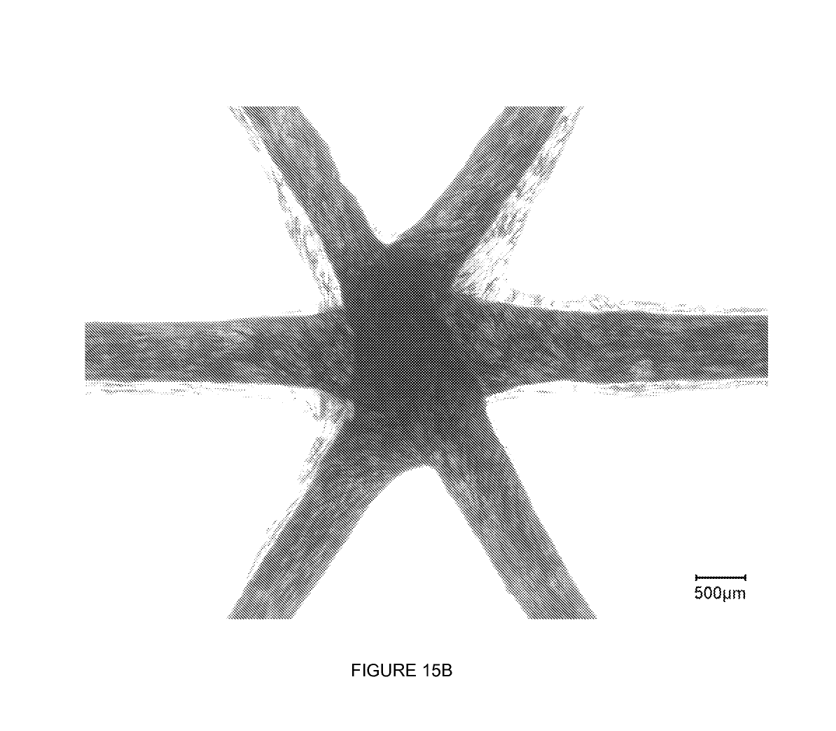

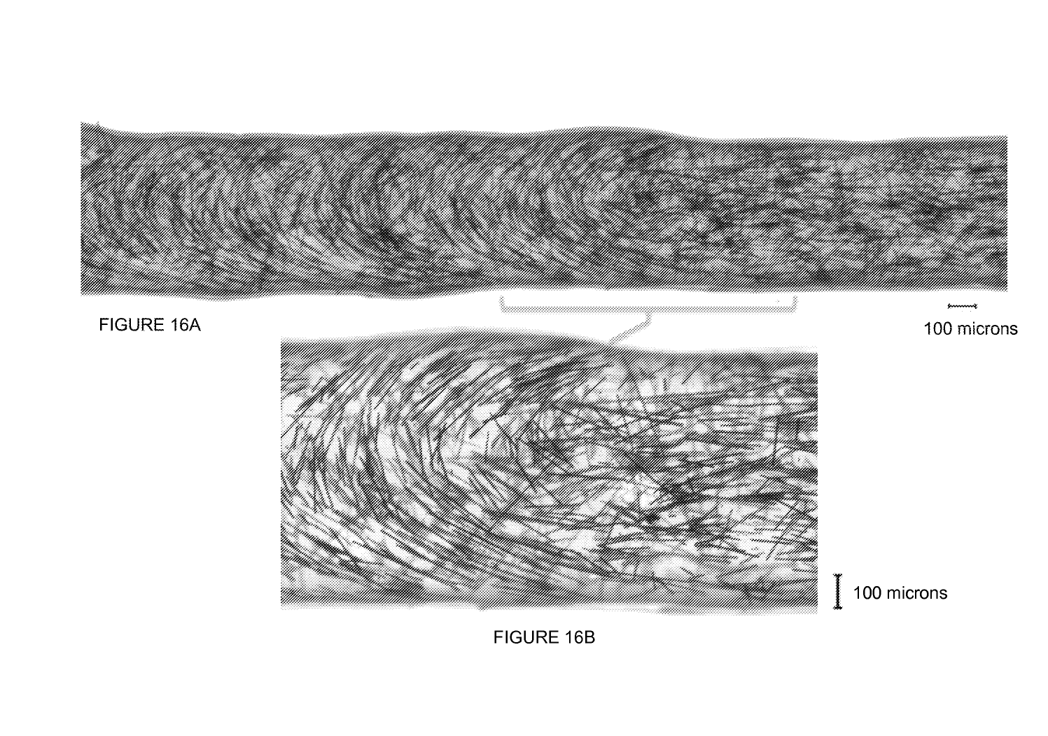

In these examples, a stepper motor connected directly to the axis control of the printer is employed to drive the rotation. Consequently, the rotation of the nozzle may be controlled as precisely as the translation of the nozzle. In addition, fiber alignment may be programmed according to location in the filament. For example, FIG. 15A shows four portions of a continuous filament fabricated by moving the nozzle at a constant translation speed and at a rotation rate that alternated between 0 deg/s and 1800 deg/s. In the bracketed regions of the filament, a majority of the fibers are aligned nearly perpendicular to the filament axis (i.e., at a helical angle φ of nearly 90 degrees); in the unbracketed regions, which show regions of the fibers formed without nozzle rotation, a majority of the fibers are aligned parallel to the filament axis.

FIG. 15B shows another example of local control of fiber orientation. In this example, a node of a cellular structure is shown where several portions of a continuous filament overlap. During fabrication of this cellular structure, the nozzle was rotated only during deposition of the portions of the continuous filament that form the node. Thus, off-axis fiber orientation can be observed at and around the node, while the fibers are aligned substantially along the longitudinal axis of the continuous filament in the remainder of the continuous filament. This local control of the fiber orientation may potentially prevent node rotation, thereby delaying failure of the cellular structure.

As explained above, only the nozzle portion of the 3D printing apparatus shown in FIGS. 13B-13C rotates during deposition, and thus the rotational inertia is reduced compared to the apparatus of FIG. 13A. Accordingly, extreme changes in fiber alignment may be achieved over smaller distances. For example, as shown in FIGS. 16A and 16B, the fiber alignment may be changed by about ±80 degrees over a distance of no greater than approximately 500 microns.

At sufficiently high rotation rates and translation speeds (e.g., about 1500 deg/s and 10 mm/s, or higher), fibers may emerge from the filament, resulting in a “spiky” printed structure with protruding fibers, as shown for example in FIG. 17. Some or all of the protruding fibers may be oriented along the helical angle φ, which is influenced by the rotational and translational motion of the nozzle during deposition. At high helical angles, a substantial portion of the protruding fibers may be oriented close to the z-direction (or the height direction of a stack of filaments as defined above). Accordingly, interlayer adhesion between adjacent filaments in the stack may be improved.

### Experimental Details

Ink Preparation: Several ink variations are prepared for printing. Each of these begin with 60 g of an epoxy resin (Epon 826, Momentive Specialty Chemicals) and 6 g of dimethyl methyl phosphonate (DMMP, Sigma Aldrich). A translucent ink (“Ink 1”) is made by adding 18 g of nanoclay (Nanocor) to the base (above) in order to impart a shear-thinning response. 2 g of milled carbon fibers (Dialead K223HM, Mitsubishi) with approximate lengths of 220 μm and diameters of 10 μm are added. Another translucent ink (“Ink 2”) is made as described for Ink 1, but substituting 2 g of longer, chopped carbon fibers (Dialead K223HE, Mitsubishi) instead of the milled carbon fibers. An additional translucent ink (“Ink 3”) is made by including a larger quantity of the milled carbon fibers (14 g instead of 2 g). A separate ink (“Ink 4”) is made by adding 16 g of nanoclay to the base (above) in order to impart a shear-thinning response. 40 g of silicon carbide whiskers (SI-TUFF SC-050, ACM) are added to improve the mechanical response, followed by the addition of 6 g of milled carbon fibers (Dialead K223HM, Mitsubishi). After mixing the above ink compositions in a SpeedMixer (FlackTek, Inc.) for 5 minutes at 1800 rpm, 3 g of Basionics VS03 latent curing agent (BASF) is added, followed by 2 minutes of additional mixing.

3D Printing: Inks are loaded into 10 cc luer-lock syringes and centrifuged to remove bubbles. Subsequently, rotating luer-lock adapters (Cole-Parmer) are connected to the luer-locks of the syringes. Luer-lock deposition nozzles are selected based on the desired diameter of the printed filaments; typically tapered plastic nozzles (Nordson EFD) of either 610 μm or 840 μm in inner diameter are employed and connected to the rotating luer-lock adapter. A custom 3D positioning stage (Aerotech) is used for printing, ensuring precise placement and translation of the deposition nozzle. During printing, the ink flow is controlled either via pressure, using a commercial pressure control box (Nordson EFD), or via volume, using a syringe pump. In the former case, a flexible plastic tube connected the pressure box (which is stationary) to the back of the syringe (which is mounted on the 3D positioning stage). In the latter case in which volume control is used, the syringe is attached to the (stationary) syringe pump, with a flexible plastic tube inserted between the (stationary) syringe barrel and the rotating luer lock (which is mounted on the 3D positioning stage).

Print paths, including commands for both translation and rotation, are produced using mecode, a coding library developed at Harvard University (Lewis group) for the facile generation of G code commands from within a Python environment. Translation speeds of 3, 10, and 15 mm/s are used for this set of experiments. These translation speeds corresponded to ink volume rates of approximately 60, 200, and 300 μL/min, respectively. These volume rates are prescribed directly by the syringe pump when volume control is used. When pressure control is used, the corresponding pressures varies dramatically based on the specific ink used, and appropriate pressures are determined empirically. Rotation rates from 0 to 2000 deg/s are applied in order to produce filaments with a large range of ratios of rotation to translation speed.

More complicated structures have also been printed while rotation is applied, including porous log pile (or crisscross) structures and honeycomb cellular structures. For these structures, rotation has also been applied differently in different locations, to demonstrate spatial control of fiber alignment (e.g., for optimally reinforcing different parts of the structure).

### 3D Printing Apparatus

One nozzle or a plurality of nozzles may be employed for 3D printing in a serial or parallel printing process. The nozzles may or may not have rotational capabilities. A nozzle suitable for printing may have an inner diameter of from about 1 micron to about 15 mm in size, and more typically from about 50 microns to about 500 microns. The size of the nozzle may be selected depending on the desired filament diameter. Depending on the injection pressure and the nozzle translation speed, the deposited filament may have a diameter ranging from about 1 micron to about 20 mm, and more typically from about 100 microns (0.1 mm) to about 5 mm. Rotation of the nozzle about its longitudinal axis may be achieved using an electric motor.

The printing process may involve more than one composite ink formulation. The composite ink formulation(s) fed to the one or more nozzles may be housed in separate syringe barrels that may be individually connected to a nozzle for printing by way of a Luer-Lok™ or other connector. The extrusion of the continuous filament may take place under an applied pressure of from about 1 psi to about 200 psi, from about 10 psi to about 80 psi, or from about 20 psi to about 60 psi. The pressure during extrusion may be constant or it may be varied. By using alternative pressure sources, pressures of higher than 100 psi or 200 psi and/or less than 1 psi may be applied during printing. A variable pressure may yield a filament having a diameter that varies along the length of the filament. The extrusion is typically carried out at ambient or room temperature conditions (e.g., from about 18° C. to about 25° C.) for viscoelastic ink formulations.

During the extrusion and deposition of the continuous filament, the nozzle may be moved along a predetermined path (e.g., from (x₁, y₁, z₁) to (x₂, y₂, z₂)) with respect to the substrate with a positional accuracy of within ±100 microns, within ±50 microns, within ±10 microns, or within ±1 micron. Accordingly, the filaments may be deposited with a positional accuracy of within ±200 microns, within ±100 microns, within ±50 microns, within ±10 microns, or within ±1 micron. The nozzle may be translated and the continuous filament may be deposited at translation speeds as high as about 3 m/s (e.g., from about 1 cm/s to about 3 m/s), and more typically in the range of from about 1 mm/s to about 500 mm/s, from about 1 mm/s to about 100 mm/s, or from about 1 mm/s to about 10 mm/s.

FIG. 13A shows an exemplary 3D printing apparatus including a rotating nozzle assembly. The apparatus also includes a motor and speed control for driving rotation of the nozzle, a rotating syringe mount for delivering ink to the nozzle, a pressure supply to control the pressure at which the ink is delivered, and a rotary union for pressure and/or ink formulation supply to the rotating head.

FIG. 13B-13C show an improved 3D printing apparatus that includes a redesigned rotating nozzle assembly. In this design, rotation of the deposition nozzle is isolated from other parts of the apparatus, allowing for lower rotational inertia and increased control over the rotation rate of the nozzle over short distances.

Referring to FIGS. 13B and 13C, the improved apparatus 100 includes a 3D positioning stage 105 for implementing translational motion of a nozzle assembly 110 and a motor 115, both of which are mounted on the 3D positioning stage 105. The nozzle assembly 110 includes a hollow stationary portion 120 connected to a hollow rotatable portion 125. The motor 115 is operatively connected to the hollow rotatable portion 125 to implement rotational motion thereof. A controller 130 is electrically connected to the 3D positioning stage 105 and to the motor 115 for independently controlling the translational motion and the rotational motion of the nozzle assembly 110.

The hollow stationary portion 120 may include at least one ink source (e.g., a syringe barrel) 165 which may be in fluid communication with the hollow rotatable portion 125. The at least one ink source 165 may comprise one or more pressure-controlled ink dispensing devices and/or one or more volume-controlled ink dispensing devices.

The hollow rotatable portion 125 may include a nozzle portion 135 for extrusion of a continuous filament therethrough that is fixedly attached to a rotatable connector 140, which in turn is rotatably attached to the hollow stationary portion 120. Accordingly, the nozzle portion 135 and the rotatable connector 140 may rotate as a unit while the hollow stationary portion 120 remains in place. The apparatus 100 may also include a substrate 145 positioned adjacent to the nozzle portion 135 for deposition of the continuous filament thereon. Typically, the substrate 145 is uncoupled from the 3D positioning stage 105, and the substrate 145 remains in place while the nozzle assembly 110 is moved.

As shown in FIG. 13C, the nozzle assembly 110 may include a rotating luer lock 150 comprising a rotating part and a fixed part. The rotating part of the luer lock may be the rotatable connector 140 described above, and the fixed part of the luer lock may be a fixed connector 155 of the hollow stationary portion 120, to which the rotatable connector 140 is rotatably attached. A belt 160 engaging the rotatable connector 140 may operatively connect the motor 115 to the hollow rotatable portion 125. The motor 115 may be a stepper motor.

### Experimental Details

Rotating Nozzle: The apparatus shown in FIG. 13B includes a nozzle assembly that was designed and built to be able to precisely rotate the deposition nozzle during printing, imparting a helical orientation to the high aspect ratio fillers contained in the inks. The entire rotating nozzle mechanism is mounted on a 3D positioning stage, and therefore translated during printing. The mechanism includes a stepper motor, bearings, a sprocket, and a belt. Half of the rotating luer lock mechanism is connected to the ink dispensing system and does not rotate, while the other half fits tightly into a sleeve bearing. The deposition nozzle emerges from the other side of the sleeve bearing. A belt connects a sprocket, which fits tightly around the sleeve bearing, to the motor. In this way, the rotation of the motor directly rotates the bearing, the half of the rotating luer lock adapter that is free to rotate, and the deposition nozzle. The motor itself is connected to the same Aerotech control system that controls the translation of the system. In this way, the x, y, and z coordinates of the deposition nozzle can be controlled independently from one another and independently from the rotation being applied.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

1. A 3D printable composite ink formulation comprising:
an uncured polymer resin, filler particles, and a latent curing agent, wherein the composite ink formulation comprises a strain-rate dependent viscosity and a plateau value of elastic storage modulus G′ of at least about 10³ Pa.

2. The composite ink formulation of claim 1, further comprising a shear yield stress of at least about 100 Pa.

3. The composite ink formulation of claim 1, wherein the uncured polymer resin is selected from the group consisting of an epoxy resin, a polyurethane resin, a polyester resin, a polyimide resin, and a polydimethylsiloxane (PDMS) resin.

4. The composite ink formulation of claim 1, wherein the uncured polymer resin is present at a concentration of from about 30 wt. % to about 95 wt. %, and
wherein the filler particles are present at a concentration of from about 5 wt. % to about 70 wt. %

5. The composite ink formulation of claim 1, wherein the latent curing agent is present at a weight concentration of from greater than 0 to about 15 parts per hundred parts of the uncured polymer resin.

6-9. (canceled)

10. The composite ink formulation of claim 1, wherein the filler particles comprise carbon.

11-13. (canceled)

14. The composite ink formulation of claim 1, wherein the filler particles comprise clay particles.

15. (canceled)

16. The composite ink formulation of claim 1, wherein the filler particles comprise high aspect ratio particles.

17-20. (canceled)

21. The composite ink formulation of claim 1, wherein the latent curing agent comprises an imidazole-based ionic liquid.

22. (canceled)

23. A 3D printed composite structure formed from the composite ink formulation of claim 1.

24-86. (canceled)

87. A filamentary structure extruded from a nozzle during 3D printing, the filamentary structure comprising:
a continuous filament including filler particles dispersed therein, at least some fraction of the filler particles in the continuous filament comprising high aspect ratio particles having a predetermined orientation with respect to a longitudinal axis of the continuous filament.

88. The filamentary structure of claim 87, wherein the high aspect ratio particles are at least partially aligned along the longitudinal axis of the continuous filament.

89. The filamentary structure of claim 88, wherein the high aspect ratio particles are highly aligned along the longitudinal axis of the continuous filament.

90. The filamentary structure of claim 87, wherein at least some fraction of the high aspect ratio particles in the continuous filament have a helical orientation comprising a circumferential component and a longitudinal component with respect to the longitudinal axis, the circumferential component being imparted by rotation of a deposition nozzle and the longitudinal component being imparted by translation of the deposition nozzle.

91. The filamentary structure of claim 87, wherein the continuous filament comprises a composite ink formulation comprising an uncured thermoset polymer resin and the high aspect ratio particles dispersed therein.

92. The filamentary structure of claim 87, wherein the continuous filament comprises a composite ink formulation comprising a thermoplastic polymer and the high aspect ratio particles dispersed therein.

93-94. (canceled)

95. A 3D printed cellular structure comprising:
a cellular network comprising cell walls separating empty cells, the cell walls comprising a polymer composite comprising filler particles dispersed in a polymer matrix,
wherein the filler particles comprise high aspect ratio particles having a predetermined orientation within the cell walls.

96-97. (canceled)

98. The 3D printed cellular structure of claim 95, wherein at least about 50% of the high aspect ratio particles have a long axis oriented within about 40 degrees of a length direction of the cell walls.

99. (canceled)

100. The 3D printed cellular structure of claim 95, wherein at least about 50% of the high aspect ratio particles have a long axis oriented within about 40 degrees of a height direction of the cell walls.

101. The 3D printed cellular structure of claim 95, wherein the high aspect ratio particles comprise an aspect ratio of at least about 10.

102-108. (canceled)
